(19) United States
(12) Patent Application Publication
(10) Pub. No.: US 2026/0279804 A1
(43) Pub. Date: Sep. 17, 2026

(54) SECONDARY BATTERY AND ELECTRIC DEVICE

(71) Applicant: Ningde Amperex Technology Limited, Ningde (CN)

(72) Inventors: Jun HE, Ningde (CN); Manman LIU, Ningde (CN)

(73) Assignee: Ningde Amperex Technology Limited, Ningde (CN)

(21) Appl. No.: 19/672,000

(22) Filed: May 8, 2026

Related U.S. Application Data
(63) Continuation of application No. PCT/CN2023/130782, filed on Nov. 9, 2023.

(51) Int. Cl. H01M 4/583; H01M 4/02; H01M 50/414; H01M 50/443; H01M 50/457

(52) U.S. Cl. CPC H01M 4/583; H01M 50/414; H01M 50/443; H01M 50/457; H01M 2004/021; H01M 2004/027; H01M 2004/028

(57) ABSTRACT

A secondary battery includes a positive electrode plate, a negative electrode plate, and a separator, where the positive electrode plate includes a positive electrode active material layer, the positive electrode active material layer including a positive electrode active material; and the negative electrode plate includes a negative electrode active material layer, the negative electrode active material layer including a negative electrode active material. A coating weight of the positive electrode active material layer is W_{z}, and a coating weight of the negative electrode active material layer is W_{f}, satisfying: 1.6W_{f}≤W_{z}≤2.2W_{f}, and 3.25 mg/cm²≤W_{f}≤5.84 mg/cm². Dᵥ99 of the positive electrode active material is 27 μm to 33 μm, and Dᵥ99 of the negative electrode active material is 23 μm to 28 μm. The separator includes a separator substrate, a first adhesive coating, and a second adhesive coating.

### CROSS REFERENCE TO THE RELATED APPLICATIONS

This application is a continuation application of International Application No. PCT/CN2023/130782, filed on Nov. 9, 2023, the contents of which are incorporated herein by reference in its entirety.

### TECHNICAL FIELD

This application relates to the field of electrochemical technology, and in particular, to a secondary battery and an electric device.

### BACKGROUND

Secondary batteries such as lithium-ion batteries, with characteristics of high specific energy, high operating voltage, low self-discharge rate, small volume, and light weight, are widely used in various fields such as electric energy storage, portable electronic devices, and electric vehicles. With the continuous iterative development of consumer lithium-ion batteries in recent years, the market demand for their charging speed is getting higher, the proportion of fast-charging products is gradually increasing, and the charging rate is continuously rising, and the consumer demand has gradually increased from 1 C to 3 C, 5 C, 6 C, 7 C, and 10 C. At a 10 C rate, the full charge time of a lithium-ion battery is less than 15 minutes, providing users with excellent experience and great convenience in daily life. However, to meet the requirements of high-rate charging and cycling, the high-temperature stability performance of lithium-ion batteries is affected. This is because under high-rate charging and high-temperature conditions (for example, temperatures greater than or equal to 40° C.), the side reactions in lithium-ion batteries increase. Therefore, how the cycling performance and high-temperature stability performance of fast-charging lithium-ion batteries are balanced has become an urgent technical problem to be resolved by those skilled in the art.

### SUMMARY

This application aims to provide a secondary battery capable of balancing cycling performance and high-temperature storage performance of the secondary battery. This application also provides an electric device using such secondary battery.

It should be noted that in the summary of this application, lithium-ion batteries are used as an example of secondary batteries to explain this application, but the secondary batteries in this application are not limited to lithium-ion batteries, and can also be secondary batteries such as sodium-ion batteries. The specific technical solution is as follows:

A first aspect of this application provides a secondary battery including an electrode assembly. The electrode assembly includes a positive electrode plate, a negative electrode plate, and a separator. The positive electrode plate includes a positive electrode active material layer, the positive electrode active material layer including a positive electrode active material; and the negative electrode plate includes a negative electrode active material layer, the negative electrode active material layer including a negative electrode active material. A coating weight of the positive electrode active material layer is W_{z}, a coating weight of the negative electrode active material layer is W_{f}, and W_{z} and W_{f} satisfy: 1.6W_{f}≤W_{z}≤2.2W_{f}, and 3.25 mg/cm²≤W_{f}≤5.84 mg/cm². Dᵥ99 of the positive electrode active material is 27 μm to 33 μm, preferably 28 μm to 31 μm. Dᵥ99 of the negative electrode active material is 23 μm to 28 μm, preferably 24 μm to 26 μm. The separator includes a separator substrate, a first adhesive coating, and a second adhesive coating, where the first adhesive coating and the second adhesive coating are respectively provided on two sides of the separator substrate; the first adhesive coating includes a first polymer binder, and an average particle size of the first polymer binder is 0.3 μm to 3 μm; and the second adhesive coating includes a second polymer binder, and an average particle size of the second polymer binder is 10 μm to 38 μm.

In this application, with the Dᵥ99 of the positive electrode active material and the negative electrode active material controlled within the above ranges, lithium ions have a shorter transmission path inside the positive electrode active material and the negative electrode active material, and a smaller transmission tortuosity inside the positive electrode plate and the negative electrode plate during the transmission process. This reduces the concentration polarization of the secondary battery, allowing the secondary battery to have good cycling performance. In this application, with the coating weights of the positive electrode active material layer and the negative electrode active material layer controlled within the above ranges, the transmission distances of lithium ions and electrons inside the positive electrode plate and inside the negative electrode plate can be shortened, thereby reducing the ohmic polarization and concentration polarization of the secondary battery, and accelerating the infiltration of the positive electrode plate and the negative electrode plate by the electrolyte. However, the high-activity design of the small-particle positive electrode active material, small-particle negative electrode active material, and low coating weights of the positive electrode active material layer and the negative electrode active material layer makes side reactions prone to occur between the positive electrode active material, the negative electrode active material, and the electrolyte. Particularly, under high temperatures, intense side reactions generate a large amount of gas, resulting in poor high-temperature performance of the lithium-ion battery. In this application, a first adhesive coating and a second adhesive coating are respectively provided on two sides of the separator, and the average particle size of the first polymer binder in the first adhesive coating and the average particle size of the second polymer binder in the second adhesive coating are controlled within the above ranges of this application, which helps strengthen the interface between the separator and the electrode plate, inhibit gas generation under high-temperature conditions, and improve cycling performance and high-temperature storage performance. On the side of the second adhesive coating of the separator, electrolyte flow channels can be generated and electrolyte can be stored, meeting the requirements of the secondary battery for high electrolyte retention (such as 1.5 g/Ah to 2.4 g/Ah) and high transmission and infiltration in the fast-charging state, thereby ensuring the rate performance and cycling performance of the battery.

In this application, through combination of the adhesive layers on two sides of the separator, the Dᵥ99 of the positive electrode active material, the Dᵥ99 of the negative electrode active material, the coating weight of the positive electrode active material layer, and the coating weight of the negative electrode active material layer, a good synergistic effect is achieved among the three. This can achieve high-temperature stability for the secondary battery while improving the cycling performance of the secondary battery.

In one embodiment of this application, the first adhesive coating is provided on a side of the separator substrate close to the negative electrode plate, and the second adhesive coating is provided on a side of the separator substrate close to the positive electrode plate. By setting the position relationship between the first adhesive coating and second adhesive coating in the separator and the negative electrode plate and the positive electrode plate, the secondary battery can further improve its cycling performance while achieving a good high-temperature stability. Additionally, for the vast majority of secondary batteries, the main requirement is fast charging for energy replenishment, without the need for fast discharging, that is, the charging rate is much greater than the discharging rate. The charging process of the secondary battery mainly involves the intercalation of lithium ions in the negative electrode. Therefore, providing the first adhesive coating with smaller particles in the separator on the negative electrode plate side can shorten the lithium ion transmission path during the charging process, thereby achieving a faster charging speed.

In one embodiment of this application, Dᵥ50 of the positive electrode active material is 10 μm to 15 μm, preferably 11 μm to 13 μm; and Dᵥ50 of the negative electrode active material is 7 μm to 12 μm, preferably 8 μm to 11 μm. With the Dᵥ50 of the positive electrode active material and the negative electrode active material controlled within the above ranges, the secondary battery can have high energy density while achieving good cycling and high-temperature stability.

In one embodiment of this application, 6.49 mg/cm²≤W_{z}≤11.69 mg/cm². With the coating weight of the positive electrode active material layer controlled within the range of this application, the transmission distances of lithium ions and electrons on the positive electrode plate are shortened while balancing the processing performance and energy density of the secondary battery. This is beneficial to reduce the impedance of the secondary battery, allowing the secondary battery to have good cycling performance.

In one embodiment of this application, a thickness of the first adhesive coating is 0.2 μm to 4 μm, and a thickness of the second adhesive coating is 5 μm to 20 μm. The first adhesive coating has smaller particle size and strong adhesion. Ensuring its thickness to be 0.2 μm to 4 μm can maximize the energy density and shorten the transmission path of lithium ions in the active material layer corresponding to the first adhesive coating while ensuring the adhesion. The second adhesive coating has larger particle size and can form electrolyte flow channels. Setting its particle size between 5 μm and 20 μm can improve the energy density while ensuring the flow infiltration of the electrolyte.

In one embodiment of this application, a single-side coating weight of the first adhesive coating is 1×10⁻⁴ mg/mm² to 1×10⁻³ mg/mm², and a single-side coating weight of the second adhesive coating is 4×10⁻⁴ mg/mm² to 2×10⁻³ mg/mm². With the single-side coating weight of the first adhesive coating controlled within the above range, the high adhesion characteristics of the first adhesive coating can be fully exerted, to better bond the electrode plate and the separator, ensuring the high-temperature stability and mechanical reliability of the secondary battery. With the single-side coating weight of the second adhesive coating controlled within the above range, the electrolyte flow channels between the electrode plate and the separator can be fully realized, improving the kinetic and cycling performance of the secondary battery. In one embodiment of this application, coverage of the first polymer binder

in the first adhesive coating per unit area is 40% to 60%. With the coverage of the first polymer binder in the first adhesive coating per unit area controlled within the above range, the high adhesion characteristics of the first adhesive coating can be fully exerted. This facilitates bonding between the separator and the electrode plate, allowing lithium ions to exhibit a fast transmission speed, thereby allowing the secondary battery to have good kinetic performance. This allows the secondary battery to have low production costs while balancing cycling performance and high-temperature stability.

In one embodiment of this application, the first polymer binder includes a core-shell structured first polymer binder or a non-core-shell structured first polymer binder, where a polymerized monomer of a core of the core-shell structured first polymer binder includes at least one of ethyl acrylate, butyl acrylate, ethyl methacrylate, styrene, chlorostyrene, fluorostyrene, methylstyrene, acrylic acid, methacrylic acid, or maleic acid, and a polymerized monomer of a shell of the core-shell structured first polymer binder includes at least one of methyl acrylate, ethyl acrylate, butyl acrylate, methyl methacrylate, ethyl methacrylate, butyl methacrylate, ethylene, ethyl chloromethyl acrylate, chlorostyrene, fluorostyrene, methylstyrene, acrylonitrile, or methacrylonitrile; and a polymerized monomer of the non-core-shell structured first polymer binder includes at least one of acrylic acid, methyl acrylate, butyl acrylate, butadiene, styrene, acrylonitrile, ethylene, fluorostyrene, chlorostyrene, or propylene. Applying the above types of first polymer binders to the first adhesive coating enables the first adhesive coating to have high adhesion.

In one embodiment of this application, coverage of the second polymer binder in the second adhesive coating per unit area is 40% to 60%. With the coverage of the second polymer binder in the second adhesive coating per unit area controlled within the above range, the separator has strong adhesion with the positive electrode plate or the negative electrode plate, allowing the secondary battery to have low production costs while balancing cycling performance and high-temperature stability.

In one embodiment of this application, a polymerized monomer of the second polymer binder includes at least one of vinylidene chloride, vinylidene fluoride, hexafluoropropylene, ethylene, propylene, vinyl chloride, chloropropene, acrylic acid, methyl acrylate, butyl acrylate, chlorostyrene, fluorostyrene, ethyl acrylate, ethyl methacrylate, methyl methacrylate, butyl methacrylate, ethyl chloromethyl acrylate, styrene, butadiene, or acrylonitrile. The use of the above types of second polymer binders allows for a large gap between the second adhesive coating and the positive electrode plate or between the second adhesive coating and the negative electrode plate while maintaining good adhesion performance. This results in good heat dissipation and facilitates transmission of electrolyte during cycling, allowing the secondary battery to have good cycling performance and high-temperature stability under fast-charging conditions.

In one embodiment of this application, the second polymer binder includes a core-shell structured second polymer binder or a non-core-shell structured second polymer binder, where a polymerized monomer of a shell of the core-shell structured second polymer binder includes at least one of vinylidene chloride, vinylidene fluoride, hexafluoropropylene, styrene, butadiene, acrylonitrile, acrylic acid, methyl acrylate, or butyl acrylate, and a core of the core-shell structured second polymer binder includes at least one of ethyl methacrylate, methyl acrylate, ethyl acrylate, butyl acrylate, methyl methacrylate, butyl methacrylate, or ethyl chloromethyl acrylate; and a polymerized monomer of the non-core-shell structured second polymer binder includes at least one of acrylic acid, methyl acrylate, butyl acrylate, butadiene, styrene, acrylonitrile, ethylene, propylene, chlorostyrene, fluorostyrene, vinylidene chloride, vinylidene fluoride, hexafluoropropylene, vinyl chloride, or chloropropene. The use of the above types of second polymer binders allows for a large gap between the second adhesive coating and the positive electrode plate or between the second adhesive coating and the negative electrode plate while maintaining good adhesion performance. This results in good heat dissipation during cycling, allowing the secondary battery to have good cycling performance and high-temperature stability under fast-charging conditions.

In one embodiment of this application, the positive electrode active material includes at least one of lithium nickel cobalt manganese oxide, lithium nickel cobalt aluminum oxide, lithium iron phosphate, lithium-rich manganese-based material, lithium cobalt oxide, lithium manganese oxide, lithium manganese iron phosphate, or lithium titanate. The above types of positive electrode active materials have high surface activity, allowing the secondary battery to have good cycling performance while achieving high-temperature stability.

In one embodiment of this application, the positive electrode active material further includes a non-metal element, where the non-metal element includes at least one of fluorine, phosphorus, boron, chlorine, silicon, or sulfur. With the above types of non-metal elements included in the positive electrode active material, the stability of the positive electrode active material can be further improved. The above elements can be added to the positive electrode active material by bulk phase doping or coating through elemental substances or compounds containing the above elements.

In one embodiment of this application, the negative electrode active material includes at least one of a carbon-based material, a silicon-based material, or a tin-based material, where the carbon-based material includes at least one of natural graphite, artificial graphite, soft carbon, hard carbon, or mesocarbon microbeads; the silicon-based material includes at least one of a silicon material, a silicon-carbon material, or a silicon-oxygen material; and the tin-based material includes at least one of elemental tin, a tin alloy, or a tin oxide. The above types of negative electrode active materials have high surface activity, allowing the secondary battery to have good cycling performance while achieving high-temperature stability.

In one embodiment of this application, for the carbon-based material, a peak intensity ratio I_{d}/I_{g} of a D peak to a G peak obtained from Raman spectroscopy satisfies: 0.1≤I_{d}/I_{g}≤1. Applying the carbon-based material satisfying the above I_{d}/I_{g} value to the secondary battery allows the secondary battery to further improve its cycling performance while achieving good high-temperature stability.

A second aspect of this application provides an electric device including the secondary battery according to any one embodiment. Therefore, the electric device has good use performance.

Beneficial Effects of this Application:

This application provides a secondary battery and an electric device. This application optimizes the electrochemical system by combining the adhesive layer of the separator, the Dᵥ99 of the positive electrode active material, the Dᵥ99 of the negative electrode active material, the coating weight of the positive electrode active material layer, and the coating weight of the negative electrode active material layer, thereby achieving a good synergistic effect among the separator, the positive electrode plate, and the negative electrode plate. As a result, the secondary battery exhibits a fast lithium ion transmission speed under a high-kinetics system, which enables a low charging temperature rise of the secondary battery while improving the charging speed of the secondary battery, meets the kinetic requirements for fast charging of the secondary battery, and achieves the high-temperature stability of the secondary battery while improving the cycling performance of the secondary battery. The electric device according to this application has good use performance.

### BRIEF DESCRIPTION OF DRAWINGS

The accompanying drawings described herein are used to provide a further understanding of this application and constitute a part of this application. The schematic embodiments of this application and the description thereof are used to explain this application, but do not constitute any improper limitation on this application.

FIG. 1 is a schematic diagram of a position relationship between a separator, a positive electrode plate, and a negative electrode plate according to an embodiment of this application;

FIG. 2 is a schematic diagram of a position relationship between a separator, a positive electrode plate, and a negative electrode plate according to another embodiment of this application;

FIG. 3 is a schematic cross-sectional structural diagram of a separator in a thickness direction thereof according to an embodiment of this application;

FIG. 4 is a schematic cross-sectional structural diagram of a separator in a thickness direction thereof according to another embodiment of this application;

FIG. 5 is a schematic cross-sectional structural diagram of a separator in a thickness direction thereof according to still another embodiment of this application; and

FIG. 6 is a Raman spectrum of a negative electrode of Example 3-3.

Reference signs: positive electrode plate 10; negative electrode plate 20; separator 30; separator substrate 31; first adhesive coating 32; second adhesive coating 33; and ceramic coating 34.

### DETAILED DESCRIPTION

To make the objectives, technical solutions, and advantages of the embodiments of this application clearer, the following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

It should be noted that in the detailed description of this application, lithium-ion batteries are used as an example of secondary batteries to explain this application, but the secondary batteries of this application are not limited to lithium-ion batteries, and can also be secondary batteries such as sodium-ion batteries.

A first aspect of this application provides a secondary battery including an electrode assembly, where the electrode assembly includes a positive electrode plate, a negative electrode plate, and a separator, where the positive electrode plate includes a positive electrode active material layer, the positive electrode active material layer including a positive electrode active material; and the negative electrode plate includes a negative electrode active material layer, the negative electrode active material layer including a negative electrode active material. A coating weight of the positive electrode active material layer is W_{z}, a coating weight of the negative electrode active material layer is W_{f}, and W_{z} and W_{f} satisfy: 1.6W_{f}≤W_{z}≤2.2W_{f}, and 3.25 mg/cm²≤W_{f}≤5.84 mg/cm². For example, the coating weight W_{f} of the negative electrode active material layer is 3.25 mg/cm², 3.5 mg/cm², 3.75 mg/cm², 4 mg/cm², 4.25 mg/cm², 4.5 mg/cm², 4.75 mg/cm², 5 mg/cm², 5.25 mg/cm², 5.5 mg/cm², 5.84 mg/cm², or in a range defined by any two of the above values. W_{z} is 1.6W_{f}, 1.7W_{f}, 1.8W_{f}, 1.9W_{f}, 2.0W_{f}, 2.1W_{f}, 2.2W_{f}, or in a range defined by any two of the above values. If the coating weight of the positive electrode active material layer is less than 1.6W_{f}, the coating weight of the negative electrode active material layer is too large compared to the coating weight of the positive electrode active material layer. When the potential of the secondary battery is reached, the delithiation speed of the positive electrode increases significantly. This results in an excessively high actual potential of the positive electrode and makes the structure prone to damage, leading to rapid degradation of the positive electrode, and causing the secondary battery unable to cycle normally. If the coating weight of the positive electrode active material layer is greater than 2.2W_{f}, the coating weight of the positive electrode active material layer is too large compared to the coating weight of the negative electrode active material layer, and excessive lithium ions are deintercalated. The negative electrode cannot accept all the lithium ions deintercalated from the positive electrode, and the lithium ions cannot be normally intercalated into the negative electrode plate, causing lithium precipitation on the negative electrode plate and affecting the cycling kinetic performance of the secondary battery. When the coating weight of the negative electrode active material layer is less than 3.25 mg/cm², the energy density of the secondary battery decreases, and the service life decreases, making it difficult to meet the process requirements of the secondary battery. When the coating weight of the negative electrode active material layer is greater than 5.84 mg/cm², the transmission distance of lithium ions inside the positive electrode plate and/or the negative electrode plate increases, and the impedance of the secondary battery increases. Dᵥ99 of the positive electrode active material is 27 μm to 33 μm, preferably 28 μm to 31 μm. For example, the Dᵥ99 of the positive electrode active material is 27 μm, 28 μm, 29 μm, 30 μm, 31 μm, 32 μm, 33 μm, or in a range defined by any two of the above values. Dᵥ99 of the negative electrode active material is 23 μm to 28 μm, preferably 24 μm to 26 μm. For example, the Dᵥ99 of the negative electrode active material is 23 μm, 24 μm, 25 μm, 26 μm, 27 μm, 28 μm, or in a range defined by any two of the above values. The separator includes a separator substrate, a first adhesive coating, and a second adhesive coating, where the first adhesive coating and the second adhesive coating are respectively provided on two sides of the separator substrate. The first adhesive coating includes a first polymer binder, and an average particle size of the first polymer binder is 0.3 μm to 3 μm. For example, the average particle size of the first polymer binder of the first adhesive coating is 0.3 μm, 0.5 μm, 1 μm, 1.5 μm, 2 μm, 2.5 μm, 3 μm, or in a range defined by any two of the above values. The second adhesive coating includes a second polymer binder, and an average particle size of the second polymer binder is 10 μm to 38 μm. For example, the average particle size of the second polymer binder of the second adhesive coating is 10 μm, 12 μm, 15 μm, 18 μm, 20 μm, 23 μm, 25 μm, 28 μm, 30 μm, 33 μm, 35 μm, 38 μm, or in a range defined by any two of the above values.

When the coating weights of the positive electrode active material layer and the negative electrode active material layer exceed the upper limit of the range in this application, the transmission distance of lithium ions inside the positive electrode plate and/or the negative electrode plate increases, and the impedance of the secondary battery increases. When the coating weights of the positive electrode active material layer and the negative electrode active material layer are below the lower limit of the range of this application, the energy density of the secondary battery decreases, and the service life decreases, making it difficult to meet the process requirements of the secondary battery.

If the Dᵥ99 of the positive electrode active material is less than 27 μm, the Dᵥ99 of the positive electrode active material is too small, indicating that the volume-based particle size of the positive electrode active material particles is too small, making the positive electrode active material particles prone to agglomeration during the preparation of the positive electrode slurry. As a result, the probability of the positive electrode active material being uniformly dispersed in the positive electrode slurry is extremely low, leading to uneven distribution of the positive electrode active material particles in the formed positive electrode active material layer. This affects the processing stability of the positive electrode plate, and causes uneven coating during application of the positive electrode slurry. Moreover, the specific surface area of the positive electrode active material particles is too large, increasing the contact interface between the positive electrode active material particles and the electrolyte, and intensifying the side reactions. Particularly, under the high-kinetics electrolyte system for ultra-fast charging, the side reactions become excessively intense, accelerating the consumption of electrolyte and the generation of side reaction products, and deteriorating the cycling performance and high-temperature stability of the secondary battery. If the Dᵥ99 of the positive electrode active material is greater than 33 μm, the Dᵥ99 of the positive electrode active material is too large, resulting in an excessively long transmission path of lithium ions inside the positive electrode active material particles, and excessively large tortuosity during transmission inside the positive electrode plate. This causes excessive concentration polarization inside the secondary battery, increasing the internal resistance of the secondary battery and reducing the cycling performance of the secondary battery.

If the Dᵥ99 of the negative electrode active material is less than 23 μm, the Dᵥ99 of the negative electrode active material is too small, indicating that the volume-based particle size of the negative electrode active material particles is too small, making the negative electrode active material particles prone to agglomeration during the preparation of the negative electrode slurry. As a result, the probability of the negative electrode active material being uniformly dispersed in the negative electrode slurry is extremely low, leading to uneven distribution of the negative electrode active material particles in the formed negative electrode active material layer. This affects the processing stability of the negative electrode plate, and causes uneven coating during application of the negative electrode slurry. Moreover, the specific surface area of the negative electrode active material particles is too large, increasing the contact interface between the negative electrode active material particles and the electrolyte, intensifying the side reactions. Particularly, under the high-kinetics electrolyte system for ultra-fast charging, the side reactions become excessively intense, accelerating the consumption of electrolyte and the generation of side reaction products, and deteriorating the cycling performance and high-temperature stability of the secondary battery. If the Dᵥ99 of the negative electrode active material is greater than 28 μm, the Dᵥ99 of the negative electrode active material is too large, resulting in an excessively long transmission path of lithium ions inside the negative electrode active material particles, and excessively large tortuosity during transmission inside the negative electrode plate. This causes excessive concentration polarization inside the secondary battery, increasing the internal resistance of the secondary battery and reducing the cycling performance of the secondary battery.

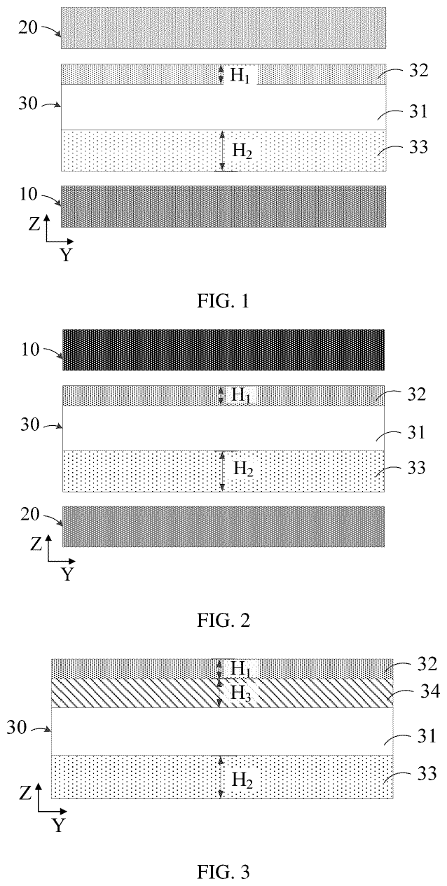

In this application, for ease of understanding, the width direction of the separator in the unfolded state is defined as Y, and the thickness direction of the separator is defined as Z. It can be understood that the length direction, width direction, and thickness direction of the positive electrode plate and the negative electrode plate in the unfolded state are the same as those of the separator. As shown in FIG. 1 and FIG. 2, the separator 30 includes a separator substrate 31, a first adhesive coating 32, and a second adhesive coating 33, where the first adhesive coating 32 and the second adhesive coating 33 are respectively provided on two sides of the separator substrate 31, and the separator substrate 31 is located between the first adhesive coating 32 and the second adhesive coating 33. The first adhesive coating 32 may be on a side close to the positive electrode plate 10, or may be on a side close to the negative electrode plate 20. As shown in FIG. 1, the first adhesive coating 32 is provided on a side of the separator substrate 31 close to the negative electrode plate 20, and the second adhesive coating 33 is provided on a side of the separator substrate 31 close to the positive electrode plate 10. As shown in FIG. 2, the first adhesive coating 32 is provided on a side of the separator substrate 31 close to the positive electrode plate 10, and the second adhesive coating 33 is provided on a side of the separator substrate 31 close to the negative electrode plate 20.

When the average particle size of the first polymer binder is less than 0.3 μm, the average particle size of the first polymer binder is too small, making the first polymer binder particles prone to agglomeration during the preparation of the first adhesive coating slurry. As a result, the probability of the first polymer binder being uniformly dispersed in the first adhesive coating slurry is extremely low, leading to uneven distribution of the first polymer binder in the formed first adhesive coating. This affects the adhesion of the first adhesive coating. When the average particle size of the first polymer binder is greater than 3 μm, the average particle size of the first polymer binder is too large, and the gaps between the first polymer binder particles are too large, which is not conducive to the cycling performance of the secondary battery. Moreover, the excessively large average particle size of the first polymer binder also increases the thickness of the first adhesive coating, increasing the volume of the secondary battery and causing loss of its energy density.

When the average particle size of the second polymer binder is less than 10 μm, the average particle size of the second polymer binder is too small, the gap between the separator and the positive electrode plate or the negative electrode plate is too small, and the transmission channel of the electrolyte is too narrow. This affects the transmission of the electrolyte, further affecting the cycling performance and kinetic performance of the secondary battery. When the average particle size of the second polymer binder is greater than 38 μm, the excessively large average particle size of the second polymer binder increases the thickness of the second adhesive coating, thereby increasing the volume of the secondary battery and causing loss of its energy density.

In general, in this application, with the Dᵥ99 of the positive electrode active material and the negative electrode active material controlled within the above ranges, lithium ions have a shorter transmission path inside the positive electrode active material and the negative electrode active material, and a smaller transmission tortuosity inside the positive electrode plate and the negative electrode plate during the transmission process. This reduces the concentration polarization of the secondary battery, allowing the secondary battery to have good cycling performance. In this application, with the coating weights of the positive electrode active material layer and the negative electrode active material layer controlled within the above ranges, the transmission distances of lithium ions and electrons inside the positive electrode plate and inside the negative electrode plate can be shortened, thereby reducing the ohmic polarization and concentration polarization of the secondary battery, and accelerating the infiltration of the positive electrode plate and the negative electrode plate by the electrolyte. However, the high-activity design of the small-particle positive electrode active material, small-particle negative electrode active material, and low coating weights of the positive electrode active material layer and the negative electrode active material layer makes side reactions prone to occur between the positive electrode active material, the negative electrode active material, and the electrolyte. Particularly, under high temperatures, intense side reactions generate a large amount of gas, resulting in poor high-temperature performance of the lithium-ion battery. In this application, a first adhesive coating and a second adhesive coating are respectively provided on two sides of the separator, and the average particle size of the first polymer binder in the first adhesive coating and the average particle size of the second polymer binder in the second adhesive coating are controlled within the above ranges of this application, which helps strengthen the interface between the separator and the electrode plate, inhibit gas generation under high-temperature conditions, and improve cycling performance and high-temperature storage performance. On the side of the second adhesive coating of the separator, electrolyte flow channels can be generated and electrolyte can be stored, meeting the requirements of the secondary battery for high electrolyte retention (such as 1.5 g/Ah to 2.4 g/Ah) and high transmission and infiltration in the fast-charging state, thereby ensuring the rate performance and cycling performance of the battery. In this application, through combination of the separator, the Dᵥ99 of the positive electrode active material, the Dᵥ99 of the negative electrode active material, the coating weight of the positive electrode active material layer, and the coating weight of the negative electrode active material layer, a good synergistic effect is achieved among the separator, the positive electrode plate and the negative electrode plate. This can achieve high-temperature stability for the secondary battery while improving the cycling performance of the secondary battery.

In this application, Dᵥ99 is a particle size where the cumulative distribution by volume reaches 99% as counted from the small particle size side. The “particles” in this application may be particles of a positive electrode active material or particles of a negative electrode active material. Positive electrode active materials and/or negative electrode active materials with different Dᵥ99 may be obtained by mechanical crushing, grinding, or the like.

In this application, the average particle size may be understood as an equivalent diameter. This application has no particular limitation on the method for controlling the average particle size of the first polymer binder and the average particle size of the second polymer binder, as long as the purpose of this application can be achieved. For example, the first polymer binder and second polymer binder with the average particle sizes within the ranges of this application may be directly purchased, or obtained by crushing, grinding, or ball milling.

The secondary battery of this application can be used under fast-charging conditions, and specifically, can be used at a charging rate of 5 C to 15 C. For example, the charging rate of the secondary battery is 5 C, 8 C, 10 C, 12 C, 15 C, or in a range defined by any two of the above values.

In one embodiment of this application, the first adhesive coating is provided on a side of the separator substrate close to the negative electrode plate, and the second adhesive coating is provided on a side of the separator substrate close to the positive electrode plate. As shown in FIG. 1, the first adhesive coating 32 is provided on a side of the separator substrate 31 close to the negative electrode plate 20, and the second adhesive coating 33 is provided on a side of the separator substrate 31 close to the positive electrode plate 10. By setting the position relationship between the first adhesive coating and second adhesive coating in the separator and the negative electrode plate and the positive electrode plate, it is ensured that the separator maintains excellent adhesion with both the positive and negative electrodes, thereby further improving the cycling performance of the secondary battery while achieving good high-temperature stability.

In one embodiment of this application, Dᵥ50 of the positive electrode active material is 10 μm to 15 μm, preferably 11 μm to 13 μm; and Dᵥ50 of the negative electrode active material is 7 μm to 12 μm, preferably 8 μm to 11 μm. For example, the Dᵥ50 of the positive electrode active material is 10 μm, 11 μm, 12 μm, 13 μm, 14 μm, 15 μm, or in a range defined by any two of the above values. The Dᵥ50 of the negative electrode active material is 7 μm, 8 μm, 9 μm, 10 μm, 11 μm, 12 μm, or in a range defined by any two of the above values. With the Dᵥ50 of the positive electrode active material and the negative electrode active material controlled within the above ranges, the risk of agglomeration of the positive electrode active material in the positive electrode slurry is low, and the risk of agglomeration of the negative electrode active material in the negative electrode slurry is low. This can control the thicknesses of the positive electrode active material layer and the negative electrode active material within the appropriate ranges while allowing the positive electrode active material and the negative electrode active material to fulfill their respective functions, thereby reducing the risk of energy density loss caused by increased thickness. This allows the secondary battery to have high energy density while achieving good cycling performance.

In this application, Dᵥ50 is a particle size where the cumulative distribution by volume reaches 50% as counted from the small particle size side. The “particles” in this application may be a positive electrode active material or a negative electrode active material. Positive electrode active materials or negative electrode active materials with different Dᵥ50 may be obtained by mechanical crushing, grinding, sieving, or the like.

In some embodiments of this application, Dᵥ10 of the positive electrode active material is 2 μm to 7 μm, and Dᵥ90 is 18 μm to 25 μm. In some embodiments of this application, the Dᵥ10 of the positive electrode active material is 3 μm to 6 μm, and the Dᵥ90 is 20 μm to 23 μm. In some embodiments of this application, the Dᵥ10 of the negative electrode active material is 3 μm to 7 μm, and the Dᵥ90 is 13 μm to 18 μm. In some embodiments of this application, Dᵥ10 of the negative electrode active material is 4 μm to 6 μm, and Dᵥ90 is 14 μm to 16 μm. For example, the Dᵥ10 of the positive electrode active material is 2 μm, 3 μm, 4 μm, 5 μm, 6 μm, 7 μm, or in a range defined by any two of the above values, and the Dᵥ90 of the positive electrode active material is 18 μm, 19 μm, 20 μm, 21 μm, 22 μm, 23 μm, 24 μm, 25 μm, or in a range defined by any two of the above values. The Dᵥ10 of the negative electrode active material is 3 μm, 4 μm, 5 μm, 6 μm, 7 μm, or in a range defined by any two of the above values, and the Dᵥ90 of the negative electrode active material is 13 μm, 14 μm, 15 μm, 16 μm, 17 μm, 18 μm, or in a range defined by any two of the above values. With the Dᵥ10 and Dᵥ90 of the positive electrode active material and the negative electrode active material controlled within the above ranges, the risk of agglomeration of the positive electrode active material in the positive electrode slurry is low, and the risk of agglomeration of the negative electrode active material in the negative electrode slurry is low. This can control the thicknesses of the positive electrode active material layer and the negative electrode active material within the appropriate ranges while allowing the positive electrode active material and the negative electrode active material to fulfill their respective functions, thereby reducing the risk of energy density loss caused by increased thickness. This allows the secondary battery to have high energy density while achieving good cycling performance.

In this application, Dᵥ10 is a particle size where the cumulative distribution by volume reaches 10% as counted from the small particle size side. Dᵥ90 is a particle size where the cumulative distribution by volume reaches 90% as counted from the small particle size side. The “particles” in this application may be particles of a positive electrode active material or particles of a negative electrode active material. Positive active materials and/or negative electrode active materials with different Dᵥ10 and Dᵥ90 may be obtained by mechanical crushing, grinding, sieving, or the like.

In one embodiment of this application, 6.49 mg/cm²≤W_{z}≤11.69 mg/cm². For example, W_{z} is 6.49 mg/cm², 7 mg/cm², 7.5 mg/cm², 8 mg/cm², 8.5 mg/cm², 9 mg/cm², 9.5 mg/cm², 10 mg/cm², 10.5 mg/cm², 11 mg/cm², 11.69 mg/cm², or in a range defined by any two of the above values. With the coating weight of the positive electrode active material layer controlled within the range of this application, the transmission distances of lithium ions and electrons on the positive electrode plate are shortened while balancing the processing performance and energy density of the secondary battery. This helps reduce the ohmic polarization and concentration polarization of the secondary battery, thereby reducing the impedance of the secondary battery and allowing the secondary battery to have good cycling performance.

In one embodiment of this application, as shown in FIG. 1 and FIG. 2, a thickness H₁ of the first adhesive coating 32 is 0.2 μm to 4 μm. For example, the thickness H₁ of the first adhesive coating is 0.2 μm, 0.5 μm, 1 μm, 1.5 μm, 2 μm, 2.5 μm, 3 μm, 3.5 μm, 4 μm, or in a range defined by any two of the above values. The particle size of the first polymer binder in the first adhesive coating is small, and the adhesion of the first adhesive coating is strong. With the thickness of the first adhesive coating controlled within the above range, the first adhesive coating has an appropriate thickness, which can reduce the risk of energy density loss caused by the increase in the volume of the secondary battery due to excessive thickness while ensuring the adhesion of the first adhesive coating. This in turn improves the energy density of the secondary battery, and shortens the transmission path of lithium ions in the active material layer corresponding to the first adhesive coating. In this way, the secondary battery can have good energy density while balancing cycling kinetic performance and high-temperature stability.

In this application, the thickness of the first adhesive coating and the thickness of the second adhesive coating are obtained by observing and measuring the parameters of the cross-section sample of the separator. This application has no particular limitation on the method for preparing the cross-section sample of the separator, as long as the purpose of this application can be achieved. For example, the cross-section of the separator can be obtained by argon ion polishing or embedding sectioning.

In one embodiment of this application, as shown in FIG. 1 and FIG. 2, a thickness H₂ of the second adhesive coating 33 is 5 μm to 20 μm. For example, the thickness H₂ of the second adhesive coating is 5 μm, 6 μm, 8 μm, 10 μm, 12 μm, 14 μm, 16 μm, 18 μm, 20 μm, or in a range defined by any two of the above values. The second polymer binder in the second adhesive coating has a relatively large particle size, allowing for formation of electrolyte flow channels. With the thickness of the second adhesive coating controlled within the above range, the second adhesive coating has an appropriate thickness, which can reduce the risk of energy density loss caused by the increase in the volume of the secondary battery due to excessive thickness while ensuring good flow infiltration of the electrolyte in the electrode plate and the separator. In this way, the secondary battery can have good energy density while balancing cycling kinetic performance and high-temperature stability.

In one embodiment of this application, a single-side coating weight of the first adhesive coating is 1×10⁻⁴ mg/mm² to 1×10⁻³ mg/mm². For example, the single-side coating weight of the first adhesive coating is 1×10⁻⁴ mg/mm², 2×10⁻⁴ mg/mm², 3×10⁻⁴ mg/mm², 4×10⁻⁴ mg/mm², 5×10⁻⁴ mg/mm², 6×10⁻⁴ mg/mm², 7×10⁻⁴ mg/mm², 8×10⁻⁴ mg/mm², 9×10⁻⁴ mg/mm², 1×10⁻³ mg/mm², or in a range defined by any two of the above values. With the single-side coating weight of the first adhesive coating controlled within the above range, the high adhesion characteristics of the first adhesive coating can be fully exerted, to better bond the electrode plate and the separator, ensuring the high-temperature stability and mechanical reliability of the secondary battery. This can also reduce the risk of energy density loss caused by the increase in the volume of the secondary battery due to excessive single-side coating weight. In this way, the secondary battery can have good energy density while balancing cycling performance and high-temperature stability.

In one embodiment of this application, a single-side coating weight of the second adhesive coating is 4×10⁻⁴ mg/mm² to 2×10⁻³ mg/mm². For example, the single-side coating weight of the second adhesive coating is 4×10⁻⁴ mg/mm², 5×10⁻⁴ mg/mm², 6×10⁻⁴ mg/mm², 7×10⁻⁴ mg/mm², 8×10⁻⁴ mg/mm², 9×10⁻⁴ mg/mm², 1×10⁻³ mg/mm², 2×10⁻³ mg/mm², or in a range defined by any two of the above values. With the single-side coating weight of the second adhesive coating controlled within the above range, the electrolyte flow channel between the electrode plate and the separator can be fully realized, improving the kinetic and cycling characteristics of the secondary battery.

In one embodiment of this application, coverage Cr₁ of the first polymer binder in the first adhesive coating per unit area is 40% to 60%. For example, the coverage of the first polymer binder in the first adhesive coating per unit area is 40%, 42%, 44%, 46%, 48%, 50%, 52%, 54%, 56%, 58%, 60%, or in a range defined by any two of the above values. With the coverage of the first polymer binder in the first adhesive coating per unit area controlled within the above range, the secondary battery has low production costs and fully exerts the high adhesion characteristics of the first adhesive coating while balancing the cycling kinetic performance and high-temperature stability. This facilitates bonding between the separator and the electrode plate, allowing lithium ions to exhibit a fast transmission speed, thereby allowing the secondary battery to have good kinetic performance.

In one embodiment of this application, the first polymer binder includes a core-shell structured first polymer binder, where a polymerized monomer of the core of the core-shell structured first polymer binder includes at least one of ethyl acrylate, butyl acrylate, ethyl methacrylate, styrene, chlorostyrene, fluorostyrene, methylstyrene, acrylic acid, methacrylic acid, or maleic acid, and a polymerized monomer of a shell of the core-shell structured first polymer binder includes at least one of methyl acrylate, ethyl acrylate, butyl acrylate, methyl methacrylate, ethyl methacrylate, butyl methacrylate, ethylene, ethyl chloromethyl acrylate, chlorostyrene, fluorostyrene, methylstyrene, acrylonitrile, or methacrylonitrile. Applying the above types of first polymer binders to the first adhesive coating enables the first adhesive coating to have high adhesion, thereby improving the high-temperature storage performance of the secondary battery and improving the high-temperature stability of the secondary battery.

In one embodiment of this application, the first polymer binder includes a non-core-shell structured first polymer binder, the polymerized monomer of the non-core-shell structured first polymer binder includes at least one of acrylic acid, methyl acrylate, butyl acrylate, butadiene, styrene, acrylonitrile, ethylene, fluorostyrene, chlorostyrene, or propylene. Applying the above types of first polymer binders to the first adhesive coating enables the first adhesive coating to have high adhesion, thereby improving the high-temperature storage performance of the secondary battery and improving the high-temperature stability of the secondary battery.

In one embodiment of this application, the first adhesive coating includes a first polymer binder, a thickener, an auxiliary binder, and a wetting agent. When the thickener is applied to the first adhesive coating, the stability of the high-adhesion coating slurry can be increased, preventing the settling of various components in the high-adhesion coating slurry. When the auxiliary binder is applied to the first adhesive coating, the first polymer binder can be bonded to the separator substrate and the ceramic coating during application of the first adhesive coating slurry. When the wetting agent is applied to the first adhesive coating, the surface energy of the first adhesive coating slurry can be reduced, preventing missed coating during application of the first adhesive coating slurry. This application has no particular limitation on the content of the first polymer binder, the thickener, the auxiliary binder, and the wetting agent in the first adhesive coating, as long as the purpose of this application can be achieved. For example, based on the mass of the first adhesive coating, the mass percentage of the first polymer binder is 85% to 95%, the mass percentage of the thickener is 0.5% to 2%, the mass percentage of the auxiliary binder is 0% to 15%, and the mass percentage of the wetting agent is 4% to 10%.

In one embodiment of this application, coverage Cr₂ of the second polymer binder in the second adhesive coating per unit area is 40% to 60%. For example, the coverage of the second polymer binder in the second adhesive coating per unit area is 40%, 42%, 44%, 46%, 48%, 50%, 52%, 54%, 56%, 58%, 60%, or in a range defined by any two of the above values. With the coverage of the second polymer binder in the second adhesive coating per unit area controlled within the above range, the second polymer binder allows for a large gap between the second adhesive coating and the positive electrode plate or between the second adhesive coating and the negative electrode plate. This provides the secondary battery with a wider electrolyte transmission channel during cycling, allowing for full realization of the electrolyte flow channel between the electrode plate and the separator. Under the condition that the electrolyte has good flow infiltration in the electrode plate and the separator, the second adhesive coating has an appropriate thickness, thereby reducing the risk of energy density loss caused by the increase in the volume of the fast-charging secondary battery due to excessive thickness. In this way, the secondary battery can also improve its energy density while balancing the cycling performance and high-temperature stability.

In one embodiment of this application, a polymerized monomer of the second polymer binder includes at least one of vinylidene chloride, vinylidene fluoride, hexafluoropropylene, ethylene, propylene, vinyl chloride, chloropropene, acrylic acid, methyl acrylate, butyl acrylate, chlorostyrene, fluorostyrene, ethyl acrylate, ethyl methacrylate, methyl methacrylate, butyl methacrylate, ethyl chloromethyl acrylate, styrene, butadiene, or acrylonitrile. The use of the above types of second polymer binders allows for a large gap between the second adhesive coating and the positive electrode plate or between the second adhesive coating and the negative electrode plate. This facilitates the transmission of electrolyte and provides good heat dissipation during cycling, thereby improving the high-temperature storage performance of the secondary battery, and improving the high-temperature stability of the secondary battery. This allows the secondary battery to have good cycling performance and high-temperature stability under fast-charging conditions.

In one embodiment of this application, the second polymer binder includes a core-shell structured second polymer binder, where a polymerized monomer of a shell of the core-shell structured second polymer binder includes at least one of vinylidene chloride, vinylidene fluoride, hexafluoropropylene, styrene, butadiene, acrylonitrile, acrylic acid, methyl acrylate, or butyl acrylate, and a core of the core-shell structured second polymer binder includes at least one of ethyl methacrylate, methyl acrylate, ethyl acrylate, butyl acrylate, methyl methacrylate, butyl methacrylate, or ethyl chloromethyl acrylate. The use of the above types of second polymer binders allows for a large gap between the second adhesive coating and the positive electrode plate or between the second adhesive coating and the negative electrode plate. This facilitates the transmission of electrolyte and provides good heat dissipation during cycling, thereby improving the high-temperature storage performance of the secondary battery, and improving the high-temperature stability of the secondary battery. This allows the secondary battery to have good cycling performance and high-temperature stability under fast-charging conditions.

In one embodiment of this application, the second polymer binder includes a non-core-shell structured second polymer binder, where a polymerized monomer of the non-core-shell structured second polymer binder includes at least one of acrylic acid, methyl acrylate, butyl acrylate, butadiene, styrene, acrylonitrile, ethylene, propylene, chlorostyrene, fluorostyrene, vinylidene chloride, vinylidene fluoride, hexafluoropropylene, vinyl chloride, or chloropropene. The use of the above types of second polymer binders allows for a large gap between the second adhesive coating and the positive electrode plate or between the second adhesive coating and the negative electrode plate. This facilitates the transmission of electrolyte and provides good heat dissipation during cycling, thereby improving the high-temperature storage performance of the secondary battery, and improving the high-temperature stability of the secondary battery. This allows the secondary battery to have good cycling performance and high-temperature stability under fast-charging conditions.

In one embodiment of this application, the second adhesive coating includes a second polymer binder and an auxiliary binder. When the auxiliary binder is applied to the second adhesive coating, the second polymer binder can be bonded to the separator substrate and the ceramic coating during application of the second adhesive coating slurry. This application has no particular limitation on the content of the second polymer binder and the auxiliary binder in the second adhesive coating, as long as the purpose of this application can be achieved. For example, based on the mass of the second adhesive coating, the mass percentage of the second polymer binder is 85% to 95%, and the mass percentage of the auxiliary binder is 0% to 15%.

This application has no particular limitation on the types of the thickener, auxiliary binder, and wetting agent, as long as the purpose of this application can be achieved. For example, the thickener includes but is not limited to sodium carboxymethyl cellulose. For example, the auxiliary binder includes but is not limited to a homopolymer or a copolymer polymerized from at least one of the following monomers: vinyl acrylate, butyl acrylate, ethyl methacrylate, acrylic acid, methacrylic acid, maleic anhydride, dicarboxylic anhydride, acrylonitrile, butadiene, and a monovinyl compound. This application has no particular limitation on the types of the monovinyl compound, as long as the purpose of this application can be achieved. For example, the monovinyl compound includes but is not limited to at least one of styrene, chlorostyrene, fluorostyrene, or methylstyrene. For example, the wetting agent includes but is not limited to at least one of sodium carboxymethyl cellulose, dimethylsiloxane, polyethylene oxide dimethylsiloxane, polyethylene oxide, oxyethylene alkylphenol ether, polyoxyethylene fatty alcohol ether, oxyethylene alkylphenol ether, polyoxyethylene fatty alcohol ether, polyoxyethylene polyoxypropylene block copolymer, or sodium dioctyl sulfosuccinate.

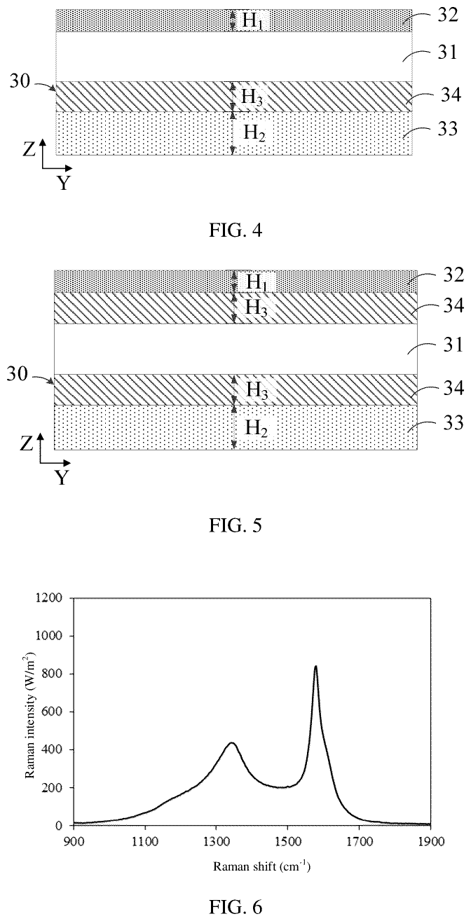

In one embodiment of this application, the separator further includes a ceramic coating, where the ceramic coating is provided between the separator substrate and the first adhesive coating, and/or the ceramic coating is provided between the separator substrate and the second adhesive coating. In some embodiments, as shown in FIG. 3, the separator 30 includes a separator substrate 31, a first adhesive coating 32, a second adhesive coating 33, and a ceramic coating 34, where the first adhesive coating 32 and the second adhesive coating 33 are respectively provided on two sides of the separator substrate 31, the ceramic coating 34 is provided between the separator substrate 31 and the first adhesive coating 32, and the second adhesive coating 33 is adjacent to a surface of the separator substrate 31 far from the ceramic coating 34. In some other embodiments, as shown in FIG. 4, the separator 30 includes a separator substrate 31, a first adhesive coating 32, a second adhesive coating 33, and a ceramic coating 34, where the first adhesive coating 32 and the second adhesive coating 33 are respectively provided on two sides of the separator substrate 31, the ceramic coating 34 is provided between the separator substrate 31 and the second adhesive coating 33, and the first adhesive coating 32 is adjacent to a surface of the separator substrate 31 far from the ceramic coating 34. In still some embodiments, as shown in FIG. 5, the separator 30 includes a separator substrate 31, a first adhesive coating 32, a second adhesive coating 33, and two ceramic coatings 34, where the first adhesive coating 32 and the second adhesive coating 33 are respectively provided on two sides of the separator substrate 31, one ceramic coating 34 is provided between the separator substrate 31 and the first adhesive coating 32, and the other ceramic coating 34 is provided between the separator substrate 31 and the second adhesive coating 33. It should be noted that the two ceramic coatings may be the same or different. The ceramic coating has good hardness and heat resistance. With the ceramic coating provided in the separator, the ceramic coating can prevent the separator from shrinking at high temperatures, thereby improving the hardness and heat resistance of the secondary battery. This allows the secondary battery to have good thermal safety performance and mechanical reliability while achieving good kinetic performance and high-temperature stability. In this application, preferably, the second adhesive coating 33 faces the positive electrode plate, and the ceramic coating 34 being provided between the separator substrate 31 and the second adhesive coating 33 can store electrolyte, and can also provide additional electrolyte flow channels in addition to the electrolyte channel formed by the second adhesive coating 33. This can reduce the thickness of the second adhesive coating 33, improve the energy density, protect the separator substrate 31 from oxidation caused by the high voltage of the positive electrode, and reduce the coating thickness of the second adhesive coating 33.

In one embodiment of this application, the ceramic coating includes ceramic particles and a ceramic coating binder. This application has no particular limitation on the types of the ceramic particles and ceramic coating binder, as long as the purpose of this application can be achieved. For example, the ceramic particles include but are not limited to at least one of alumina, boehmite, titania, silica, zirconia, stannic oxide, magnesium hydroxide, magnesia, zinc oxide, barium sulfate, boron nitride, aluminum nitride, or silicon nitride. The ceramic coating binder includes but is not limited to at least one of polyvinylidene fluoride, polyacrylic acid, polymethyl methacrylate, polybutyl acrylate, or polyacrylonitrile. This application has no particular limitation on the content of the ceramic particles and ceramic coating binder in the ceramic coating, as long as the purpose of this application can be achieved. For example, based on the mass of the ceramic coating, the mass percentage of the ceramic particles is 5% to 95%, and the mass percentage of the ceramic coating binder is 5% to 95%. This application has no particular limitation on the average particle size of the ceramic particles, as long as the purpose of this application can be achieved. For example, the average particle size of the ceramic particles is 1 μm to 3 μm. This application has no particular limitation on the thickness of the ceramic coating. For example, the thickness of the ceramic coating may be 0.5 μm to 6 μm. This application has no particular limitation on the separator substrate, as long as the purpose of this application can be achieved. For example, a structure of the separator substrate includes a single-layer structure or a multi-layer composite structure, where the multi-layer composite structure may be a two-layer composite structure, a three-layer composite structure, or a four-layer composite structure. The type of the separator substrate includes at least one of polyethylene (PE), polypropylene (PP), or polyethylene terephthalate (PET). The thickness of the separator substrate may be 3 μm to 20 μm.

This application has no particular limitation on the method for controlling the average particle size of the ceramic particles, as long as the purpose of this application can be achieved. For example, ceramic particles with the average particle size within the range of this application may be directly purchased, or obtained by crushing, grinding, or ball milling.

In one embodiment of this application, the positive electrode active material includes at least one of lithium nickel cobalt manganese oxide, lithium nickel cobalt aluminum oxide, lithium iron phosphate, lithium-rich manganese-based material, lithium cobalt oxide, lithium manganese oxide, lithium manganese iron phosphate, or lithium titanate. The chemical formula of the “lithium-rich manganese-based material” is LiMnO·LiMO, where M may include at least one of Niₙ, Coₙ, or Mnₙ, and n may be 1, 2, or 3. The above types of positive electrode active materials have high surface activity, and when applied to the secondary battery, can increase the active sites for lithium ion intercalation and deintercalation, and reduce the electrochemical polarization of the secondary battery, thereby reducing the impedance of the secondary battery. This allows the secondary battery to have good cycling performance while achieving high-temperature stability.

In one embodiment of this application, the positive electrode active material further includes a non-metal element, where the non-metal element includes at least one of fluorine, phosphorus, boron, chlorine, silicon, or sulfur. This application has no particular limitation on the content of the non-metal element in the positive electrode active material, as long as the purpose of this application can be achieved. For example, based on the mass of the positive electrode active material, the mass percentage of the non-metal element is 0.1% to 10%. For example, the mass percentage of the non-metal element is 0.1%, 1%, 2%, 3%, 4%, 5%, 6%, 7%, 8%, 9%, 10%, or in a range defined by any two of the above values. With the above types of non-metal elements included in the positive electrode active material, the stability of the positive electrode active material can be further improved, and the structural stability of the positive electrode plate can be improved, thereby improving the cycling performance of the secondary battery.

In one embodiment of this application, the negative electrode active material includes at least one of a carbon-based material, a silicon-based material, or a tin-based material, where the carbon-based material includes at least one of natural graphite, artificial graphite, soft carbon, hard carbon, or mesocarbon microbeads, the silicon-based material includes at least one of a silicon material, a silicon-carbon material, or a silicon-oxygen material, and the tin-based material includes at least one of elemental tin, a tin alloy, or a tin oxide. The above types of negative electrode active materials have high surface activity, and when applied to the secondary battery, can increase the active sites for lithium ion intercalation and deintercalation, and reduce the electrochemical polarization of the secondary battery, thereby reducing the impedance of the secondary battery. This allows the secondary battery to have good cycling performance while achieving high-temperature stability.

In one embodiment of this application, for the carbon-based material, a peak intensity ratio I_{d}/I_{g} of a D peak to a G peak obtained from Raman spectroscopy satisfies: 0.1≤I_{d}/I_{g}≤1. For example, I_{d}/I_{g} is 0.1, 0.2, 0.4, 0.6, 0.8, 1, or in a range defined by any two of the above values. This indicates that the surface of the carbon-based material contains amorphous carbon. The surface of the carbon-based material containing amorphous carbon can improve the electrochemical activity of the carbon-based material, allowing smoother intercalation of lithium ions during cycling of the secondary battery. This helps reduce the electrochemical polarization of the secondary battery, thereby reducing the internal impedance of the secondary battery and improving its cycling kinetic performance. Applying the carbon-based material satisfying the above I_{d}/I_{g} value to the secondary battery allows the secondary battery to further improve its cycling performance while achieving good high-temperature stability.

In this application, the D peak is a peak in the Raman spectrum of carbon-based material particles with a shift range of 1300 cm⁻¹ to 1400 cm⁻¹, and the G peak is a peak in the Raman spectrum of carbon-based material particles with a shift range of 1530 cm⁻¹ to 1630 cm⁻¹.

This application has no particular limitation on the method for controlling the I_{d}/I_{g} value, as long as the purpose of this application can be achieved. For example, commercially available carbon-based materials with different contents of amorphous carbon on the surface may be selected, and combined with the “Raman test” method in this application to determine the I_{d}/I_{g} value of the carbon-based material and select the carbon-based material with the desired I_{d}/I_{g} value.

This application has no particular limitation on the preparation method of the carbon-based material, as long as the purpose of this application can be achieved. For example, the preparation method of the carbon-based material may include but is not limited to: mixing the carbon-based material and amorphous carbon to uniformity, then heating to 500° C. to 1500° C., and holding at that temperature for 10 h to 20 h to obtain a carbon-based material with amorphous carbon coating the surface. The positive electrode plate of this application includes a positive electrode current collector and a positive electrode active material layer provided on at least one surface of the positive electrode current collector. In some embodiments, the positive electrode active material layer is provided on one surface of the positive electrode current collector. In some other embodiments, the positive electrode active material layer is provided on both surfaces of the positive electrode current collector. The “surface” may be part or all of the surface of the positive electrode current collector. This application has no particular limitation on the positive electrode current collector, as long as the purpose of this application can be achieved. For example, the positive electrode current collector may include aluminum foil, aluminum alloy foil, a composite current collector (such as an aluminum-carbon composite current collector), or the like. This application has no particular limitation on the thicknesses of the positive electrode current collector and the positive electrode active material layer, as long as the purpose of this application can be achieved. For example, the thickness of the positive electrode current collector is 5 μm to 20 μm, preferably 6 μm to 18 μm. The thickness of the single-side positive electrode material layer is 30 μm to 120 μm. In this application, the positive electrode active material layer may further include a conductive agent and a binder. This application has no particular limitation on the type of the positive electrode binder in the positive electrode active material layer, as long as the purpose of this application can be achieved. For example, the positive electrode binder may include but is not limited to at least one of polyvinylidene fluoride, vinylidene fluoride-hexafluoropropylene copolymer, polyamide, polyacrylonitrile, polyacrylate, polyacrylic acid, polyacrylate salt, polyvinylpyrrolidone, polyvinyl ether, polymethyl methacrylate, polytetrafluoroethylene, or polyhexafluoropropylene. This application has no particular limitation on the type of the conductive agent in the positive electrode active material layer, as long as the purpose of this application can be achieved. For example, the conductive agent may include but is not limited to at least one of conductive carbon black (Super P), carbon nanotubes (CNTs), carbon fiber, flake graphite, Ketjenblack, graphene, a metal material, or a conductive polymer. The carbon nanotubes may include but are not limited to single-walled carbon nanotubes and/or multi-walled carbon nanotubes. The carbon fiber may include but is not limited to vapor-grown carbon fiber (VGCF) and/or nano carbon fiber. The metal material may include but is not limited to metal powder and/or metal fiber. Specifically, the metal may include but is not limited to at least one of copper, nickel, aluminum, or silver. The conductive polymer may include but is not limited to at least one of a polyphenyl derivative, polyaniline, polythiophene, polyacetylene, or polypyrrole. This application has no particular limitation on the mass ratio of the positive electrode active material, conductive agent, and positive electrode binder in the positive electrode active material layer. Those skilled in the art can make selection according to actual needs, as long as the purpose of this application can be achieved.

The negative electrode plate of this application includes a negative electrode current collector and a negative electrode active material layer provided on at least one surface of the negative electrode current collector. In some embodiments, the negative electrode active material layer is provided on one surface of the negative electrode current collector. In some other embodiments, the negative electrode active material layer is provided on both surfaces of the negative electrode current collector. The “surface” may be part or all of the surface of the negative electrode current collector. This application has no particular limitation on the negative electrode current collector, as long as the purpose of this application can be achieved. For example, the negative electrode current collector may include copper foil, copper alloy foil, nickel foil, stainless steel foil, titanium foil, foamed nickel, foamed copper, or a composite current collector (such as a lithium-copper composite current collector, a carbon-copper composite current collector, a nickel-copper composite current collector, or a titanium-copper composite current collector). This application has no particular limitation on the thicknesses of the negative electrode current collector and the negative material layer, as long as the purpose of this application can be achieved. For example, the thickness of the negative electrode current collector is 4 μm to 20 μm, and the thickness of the negative electrode active material layer is 30 μm to 130 μm. Optionally, the negative electrode active material layer may further include a conductive agent and a binder. This application has no particular limitation on the type of the conductive agent in the negative electrode active material layer, as long as the purpose of this application can be achieved. For example, the conductive agent may be of the same type as the conductive agent in the positive electrode active material layer. This application has no particular limitation on the type of the negative electrode binder in the negative electrode active material layer, as long as the purpose of this application can be achieved. For example, the negative electrode binder may be of the same type as the positive electrode binder in the positive electrode active material layer. This application has no particular limitation on the mass ratio of the negative electrode active material, the conductive agent, and the negative electrode binder in the negative electrode active material layer, as long as the purpose of this application can be achieved.

The electrolyte in the secondary battery of this application includes a lithium salt and a non-aqueous solvent. The lithium salt may include at least one of lithium hexafluorophosphate, lithium difluorophosphate, lithium tetrafluoroborate, lithium hexafluoroarsenate, lithium perchlorate, lithium bisfluorosulfonimide, lithium bistrifluoromethanesulfonimide, lithium bisoxalate borate, or lithium difluorooxalate borate. This application does not limit the content of the lithium salt in the electrolyte, as long as the purpose of this application can be achieved. This application has no particular limitation on the non-aqueous solvent, as long as the purpose of this application can be achieved. For example, the non-aqueous solvent may include but is not limited to at least one of a carbonate compound, a carboxylate compound, an ether compound, or other organic solvents. The carbonate compound may include but is not limited to at least one of a chain carbonate compound, a cyclic carbonate compound, or a fluorinated carbonate compound. The chain carbonate compound may include but is not limited to at least one of dimethyl carbonate, diethyl carbonate, dipropyl carbonate, methyl propyl carbonate, ethyl propyl carbonate, or methyl ethyl carbonate. The cyclic carbonate may include but is not limited to at least one of ethylene carbonate, propylene carbonate (PC), vinylene carbonate, or vinyl ethylene carbonate. The fluorinated carbonate compound may include but is not limited to at least one of fluoroethylene carbonate, 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene carbonate, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compound may include but is not limited to at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvents may include but are not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. The electrolyte in the secondary battery of this application may further include an additive. This application has no particular limitation on the types of the additive, as long as the purpose of this application can be achieved. For example, the additive includes but is not limited to at least one of succinonitrile, glutaronitrile, pimelonitrile, 1,2-bis(2-cyanoethoxy) ethane, 1,2-bis(2-cyanoethoxy) propane, or 1,2 (3-cyanopropoxy) ethane. This application does not limit the content of the additive in the electrolyte, as long as the purpose of this application can be achieved.

In one embodiment of this application, the secondary battery further includes a housing, where the electrode assembly and the electrolyte are accommodated in the housing. This application has no particular limitation on the housing, which may be a housing well known in the art, as long as the purpose of this application can be achieved. For example, the housing includes but is not limited to an aluminum-plastic film or a steel shell.

This application has no particular limitation on the type of the secondary battery, which may include any apparatus where electrochemical reactions take place. For example, the secondary battery may include but is not limited to: a lithium metal secondary battery, a lithium-ion secondary battery (lithium-ion battery), a sodium-ion secondary battery (sodium-ion battery), a lithium polymer secondary battery, and a lithium-ion polymer secondary battery.

This application has no particular limitation on the preparation method of the separator, as long as the purpose of this application can be achieved.

For example, in one embodiment, the preparation method of the separator includes but is not limited to the following steps: (1) mixing the first polymer binder, the thickener, the auxiliary binder, and the wetting agent to uniformity to obtain a first adhesive coating slurry; (2) mixing the second polymer binder and the auxiliary binder to uniformity to obtain a second adhesive coating slurry; and (3) applying the first adhesive coating slurry to one surface of the separator substrate, followed by drying, to form a first adhesive coating on one surface of the separator substrate; and applying the second adhesive coating slurry to the other surface of the separator substrate, followed by drying, to form a second adhesive coating on the other surface of the separator substrate, thereby obtaining the separator.

For example, in another embodiment, the preparation method of the separator includes but is not limited to the following steps: (1) mixing the first polymer binder, the thickener, the auxiliary binder, and the wetting agent to uniformity to obtain a first adhesive coating slurry; (2) mixing the second polymer binder and the auxiliary binder to uniformity to obtain a second adhesive coating slurry; (3) mixing the ceramic particles and the ceramic coating binder to uniformity to obtain a ceramic coating slurry; and (4) applying the ceramic coating slurry to one surface of the separator substrate, followed by drying, to form a ceramic coating on one surface of the separator substrate; applying the first adhesive coating slurry to the surface of the ceramic coating, followed by drying, to form a first adhesive coating on the surface of the ceramic coating far from the separator substrate; and applying the second adhesive coating slurry to the other surface of the separator substrate, followed by drying, to form a second adhesive coating on the other surface of the separator substrate, thereby obtaining the separator.

For example, in still another embodiment, the preparation method of the separator includes but is not limited to the following steps: (1) mixing the first polymer binder, the thickener, the auxiliary binder, and the wetting agent to uniformity to obtain a first adhesive coating slurry; (2) mixing the second polymer binder and the auxiliary binder to uniformity to obtain a second adhesive coating slurry; (3) mixing the ceramic particles and the ceramic coating binder to uniformity to obtain a ceramic coating slurry; and (4) applying the ceramic coating slurry to one surface of the separator substrate, followed by drying, to form a ceramic coating on one surface of the separator substrate; applying the second adhesive coating slurry to the surface of the ceramic coating, followed by drying, to form a second adhesive coating on the surface of the ceramic coating far from the separator substrate; and applying the first adhesive coating slurry to the other surface of the separator substrate, followed by drying, to form a first adhesive coating on the other surface of the separator substrate, thereby obtaining the separator.

For example, in still another embodiment, the preparation method of the separator includes but is not limited to the following steps: (1) mixing the first polymer binder, the thickener, the auxiliary binder, and the wetting agent to uniformity to obtain a first adhesive coating slurry; (2) mixing the second polymer binder and the auxiliary binder to uniformity to obtain a second adhesive coating slurry; (3) mixing the ceramic particles and the ceramic coating binder to uniformity to obtain a ceramic coating slurry; and (4) applying the ceramic coating slurry to one surface of the separator substrate, followed by drying, to form a ceramic coating on one surface of the separator substrate; applying the ceramic coating slurry to the other surface of the separator, followed by drying, to form a ceramic coating on the other surface of the separator substrate; applying the second adhesive coating slurry to the surface of the first ceramic coating far from the separator substrate, followed by drying, to form a second adhesive coating on the surface of the first ceramic coating far from the separator substrate; and applying the first adhesive coating slurry to the surface of the second ceramic coating far from the separator substrate, followed by drying, to form a first adhesive coating on the surface of the second ceramic coating far from the separator substrate, thereby obtaining the separator.

This application has no particular limitation on the solid content of the first adhesive coating slurry, as long as the purpose of this application can be achieved. For example, the solid content of the first adhesive coating slurry is 60 wt % to 80 wt %. This application has no particular limitation on the solid content of the second adhesive coating slurry, as long as the purpose of this application can be achieved. For example, the solid content of the second adhesive coating slurry is 60 wt % to 80 wt %. This application has no particular limitation on the solid content of the ceramic coating slurry, as long as the purpose of this application can be achieved. For example, the solid content of the ceramic coating slurry is 30 wt % to 40 wt %. This application has no particular limitation on the temperature and time of the drying. Those skilled in the art can make selection and adjustment according to actual needs, as long as the purpose of this application can be achieved.

This application has no particular limitation on the preparation method of the secondary battery, and a preparation method well known in the art can be selected, as long as the purpose of this application can be achieved. For example, the preparation method of the secondary battery includes but is not limited to the following steps: stacking the separator, the positive electrode plate, the separator, and the negative electrode plate in order, winding or folding the resulting stack as needed to obtain a wound electrode assembly, placing the electrode assembly into the housing, injecting the electrolyte into the housing, and sealing the housing, to obtain the secondary battery; or stacking the separator, the positive electrode plate, the separator, and the negative electrode plate in order, fixing the four corners of the entire laminated structure to obtain a laminated electrode assembly, placing the electrode assembly into the housing, injecting the electrolyte into the housing, and sealing the housing, to obtain the secondary battery.

A second aspect of this application provides an electric device including the secondary battery in any one of the foregoing embodiments. Therefore, the electric device has good use performance.

The electric device of this application is not particularly limited, and may be any electric device known in the prior art. For example, the electric device may include but is not limited to: a notebook computer, a pen-input computer, a mobile computer, an e-book player, a portable phone, a portable fax machine, a portable copier, a portable printer, a head-mounted stereo headphone, a video recorder, an LCD television, a portable cleaner, a portable CD player, a mini disc, a transceiver, an electronic organizer, a calculator, a memory card, a portable recorder, a radio, a backup power supply, a motor, an automobile, a motorcycle, a power-assisted bicycle, a bicycle, a lighting fixture, a toy, a game console, a clock, an electric tool, a flashlight, a camera, a household large-scale storage battery, and a lithium-ion capacitor.

### EXAMPLES

The following describes the embodiments of this application more specifically by using examples and comparative examples. Various tests and evaluations are conducted according to the methods described below.

### Test Methods and Equipment:

### Test for Related Particle Sizes:

The average particle sizes of the first polymer binder and the second polymer binder can be obtained by observing the corresponding surface of the separator perpendicular to the thickness direction through scanning electron microscopy (SEM), measuring the diameters of 10 first polymer binder particles and 10 second polymer binder particles, and calculating the respective average values. The first polymer binder and the second polymer binder are distinguished by the particle diameters. Specifically, on the surface of the separator, the side with the smaller particle diameter is the first adhesive coating containing the first polymer binder, and 10 first polymer binders are arbitrarily selected in the first adhesive coating to obtain the average particle size of the first polymer binder; the side with the larger particle diameter is the second adhesive coating containing the second polymer binder, and 10 second polymer binders are arbitrarily selected in the second adhesive coating to obtain the average particle size of the second polymer binder. Since the particles of the first polymer binder and the second polymer binder deform under the pressure in the processes such as cold pressing and hot pressing during preparation of the secondary battery, resulting in different diameters of the particles in the thickness direction of the separator and in a direction perpendicular to the thickness direction of the separator. The average particle sizes of the first polymer binder and the second polymer binder in this application are the diameters measured on the surface perpendicular to the thickness direction of the separator, so the above-mentioned average particle sizes of the first polymer binder and the second polymer binder are not limited by the thicknesses of the first adhesive coating and the second adhesive coating.

The average particle size of the ceramic particles on the separator can be obtained by observing the surface of the separator perpendicular to the thickness direction through scanning electron microscopy (SEM), measuring the diameters of 10 ceramic particles, and calculating the average value. The average diameter of the ceramic particles in this application is a diameter measured on the surface of the particles perpendicular to the thickness direction of the separator, so the average particle size of the ceramic particles is also not limited by the thickness of the ceramic coating.

The Dᵥ50 and Dᵥ99 of the positive electrode active material and the negative electrode active material are measured using a laser particle size analyzer.

### (1) Test for Coating Weight W_{z} of Positive Active Material Layer:

The lithium-ion battery was discharged at 0.5 C to 3.0 V, and then disassembled to obtain the positive electrode plate. The impurities on the surface of the positive electrode plate were cleaned with dimethyl carbonate (DMC), followed by drying. A sample with an area of A mm² was cut from the positive electrode plate and weighed on a balance, with the weight recorded as p₁. Then the positive electrode active material layer was washed off the positive electrode plate, and the positive electrode current collector was weighed on a balance, with the weight recorded as p₂.

If it is a positive electrode plate with single-side coating of the positive electrode active material layer, W_{z}=(p₁−p₂)/A.

If it is a positive electrode plate with double-side coating of the positive electrode active material layer, W_{z}=(p₁−p₂)/2A.

### (2) Test for Coating Weight W_{f} of Negative Active Material Layer:

The lithium-ion battery was discharged at 0.5 C to 3.0 V, and disassembled to obtain the negative electrode plate. The impurities on the surface of the negative electrode plate were cleaned with DMC, followed by drying. A sample with an area of B mm² was cut from negative electrode plate, and weighed on a balance, with the weight recorded as q₁. Then the negative electrode active material layer was washed off the negative electrode plate, and the negative electrode current collector was weighed on a balance, with the weight recorded as q₂.

If it is a negative electrode plate with single-side coating of the negative electrode active material layer, W_{f}=(q₁−q₂)/B.

If it is a negative electrode plate with double-side coating of the negative electrode active material layer, W_{f}=(q₁−q₂)/2B.

### Test for Single-Side Coating Weight of First Adhesive Coating:

Each lithium-ion battery of the examples and comparative examples was discharged at 0.5 C to 3.0 V, and then disassembled to obtain the separator. The impurities on the surface of the separator were cleaned with DMC, followed by drying at 60° C., to obtain the test sample of the separator. A small disc with an area of S mm² was punched from the test sample of the separator, and its mass was weighed and recorded as m₁. Then the first adhesive coating was peeled off from the small disc, and the mass of the small disc with the first adhesive coating removed was obtained and recorded as m₂. The single-side coating weight of the first adhesive coating was (m₁−m₂)/S.

### Test for Single-Side Coating Weight of Second Adhesive Coating:

Each lithium-ion battery of the examples and comparative examples was discharged at 0.5 C to 3.0 V, and then disassembled to obtain the separator. The impurities on the surface of the separator were cleaned with DMC, followed by drying at 60° C., to obtain the test sample of the separator. A small disc with an area of S mm² was punched from the test sample of the separator, and its mass was weighed and recorded as m₃. Then the second adhesive coating was peeled off from the small disc, and the mass of the small disc with the second adhesive coating removed was obtained and recorded as m₄. The single-side coating weight of the second adhesive coating was (m₃−m₄)/S.

### Test for Thickness of First Adhesive Coating and Thickness of Second Adhesive Coating:

Argon ion polishing was performed on the coated separator to obtain the cross-section of the separator, and the thickness of the first adhesive coating and the second adhesive coating was measured by observing the cross-section with SEM. The side with the smaller particle diameter in the cross-section of the separator is the first adhesive coating containing the first polymer binder, and the side with the larger particle diameter is the second adhesive coating containing the second polymer binder.

### Test for Coverage of First Polymer Binder:

SEM was used to observe the surface of the side of the separator provided with the first adhesive coating, and the coverage was obtained by calculating the ratio of the area occupied by the first polymer binder in the electron microscope image to the total separator area sampled in the electron microscope image.

### Test for Coverage of Second Polymer Binder:

SEM was used to observe the surface of the side of the separator provided with the second adhesive coating, and the coverage was obtained by calculating the ratio of the area occupied by the second polymer binder in the electron microscope image to the total separator area sampled in the electron microscope image.

### Raman (Raman) Test:

The lithium-ion battery was discharged at 0.5 C to 3.0 V, and then disassembled to obtain the negative electrode plate which was then washed with dimethyl carbonate and dried. An area of 100 μm×100 μm was selected on the negative electrode active material layer, and the negative electrode active material particles in this area were scanned using a laser confocal Raman spectrometer (Raman, HR Evolution, HORIBA Scientific), to obtain the D peak and G peak of all negative electrode active material particles in this area. The data was processed using LabSpec software, to obtain the peak intensities of the D peak and G peak for each negative electrode active material particle, denoted as I_{d} and I_{g} respectively. The laser wavelength of the Raman spectrometer is in the range of 532 nm to 785 nm. The value of I_{d}/I_{g} is the average value of the I_{d} to I_{g} ratios of all negative electrode active material particles measured in this range.

### Test for Adhesion Force F₁ of Separator to Positive Electrode Plate:

The dry-pressing adhesion force between the separator and the positive electrode plate was measured according to the 180° peel test standard. Each lithium-ion battery under test in the examples and comparative examples were disassembled, the negative electrode plate was peeled off, and the separator and the positive electrode plate were soaked in dimethyl carbonate for 20 minutes to remove the electrolyte. Then the separator and the positive electrode plate were cut into 54.2 mm×72.5 mm samples, and the separator and the positive electrode plate were laminated, and hot pressed using a hot press machine under conditions of 85° C., 1 MPa, and 85 s. The laminated sample was cut into 15 mm×54.2 mm strips to obtain test strips for testing the adhesion force of the separator to the positive electrode plate. A 15 mm×55 mm double-sided tape (NITTO.NO5000NS) was attached to a steel plate, and then the test strip was attached to the double-sided tape with the test surface facing down. A 15 mm×70 mm paper tape was connected to one end of the test strip through double-sided tape, and a 2 kg roller was manually pushed to roll on the test strip 8 times to obtain the test sample. A tensile machine was used for testing. The test sample was fixed on the test bench, and the paper tape was folded upward by 180° and fixed with a clamp. Then the tensile machine started pulling the paper tape at a speed of 50 mm/min until the separator and the positive electrode plate on the surface of the double-sided tape were separated. The test ended, and the test data was saved. The adhesion force F₁ between the separator and the positive electrode plate was calculated based on the pulling force at the point of separation between the separator and the positive electrode plate and the tensile displacement, in units of N/m.

### Test for Adhesion Force F₂ of Separator to Negative Electrode Plate:

The dry-pressing adhesion force between the separator and the negative electrode plate was measured according to the 180° peel test standard. Each lithium-ion battery under test in the examples and comparative examples were disassembled, the positive electrode plate was peeled off, and the separator and the negative electrode plate were soaked in dimethyl carbonate for 20 minutes to remove the electrolyte. Then the separator and the negative electrode plate were cut into 54.2 mm×72.5 mm samples, and the separator and the negative electrode plate were laminated, and hot pressed using a hot press machine under conditions of 85° C., 1 MPa, and 85 s. The laminated sample was cut into 15 mm×54.2 mm strips to obtain test strips for testing the adhesion force of the separator to the negative electrode plate. Then, following the above process of testing the adhesion force of the separator to the positive electrode plate, the adhesion force F₂ between the separator and the negative electrode plate was measured, in units of N/m.

### Test for Cycling Performance:

The lithium-ion batteries of each example and comparative example were tested for cycling performance under a charging rate of 10 C. The specific steps are as follows.

The test temperature was adjusted to constant 25° C., and the test was started: (1) charging to 4.2 V at a constant current of 10 C; (2) charging to 4.3 V at a constant current of 8 C; (3) charging to 4.45 V at a constant current charge of 6 C; (4) charging to 0.05 C at a constant voltage of 4.45 V; (5) left standing for 5 min; (6) discharging to 3.0 V at a constant current of 1 C; (7) left standing for 5 min; (8) repeating steps (1) to (7) for 1000 cycles (cls); end.

$$Capacity retention rate ( \% ) = discharge capacity after 1000 cycles / first - cycle discharge capacity \times 100 \% .$$

### Test for High-Temperature Stability:

The thickness of the prepared lithium-ion battery, also referred to as the initial thickness of the lithium-ion battery, was measured.

The lithium-ion battery was fully charged according to the following steps: charging to 4.45 V at a constant current of 0.7 C, and charging to 0.02 C at a constant voltage of 4.45 V.

The lithium-ion battery was placed in a high and low temperature box at 80° C. for 8 h, and then the thickness of the lithium-ion battery was measured. The test ended.

Swelling rate of lithium-ion battery=(thickness of lithium-ion battery after high-temperature storage−initial thickness of lithium-ion battery)/initial thickness of lithium-ion battery×100%. The high-temperature stability was characterized by the swelling rate. A smaller swelling rate indicates a better high-temperature stability.

### Example 1-1

### <Preparation of Separator>

A single-layer polypropylene film with a thickness of 5 μm was used as the separator substrate.

The ceramic particles aluminum oxide, the ceramic coating binder butadiene-styrene polymer (with a mass ratio of butadiene to styrene of 2:3, the weight average molecular weight Mw=7×10⁶), and the solvent deionized water were mixed in a mass ratio of 35:10:55. Specifically: first, 30 kg of butadiene-styrene polymer and deionized water were added to a 60 L double planetary mixer, and dispersed at 45° C. for 3 hours; then 21 kg of aluminum oxide ceramic particles were added to the mixer, and dispersed at a high speed at 45° C. for 2 hours; and ball milling was performed using a nano grinder for 1.5 hours, with the grinding medium being spherical zirconia beads having a diameter of 6 μm, to obtain the ceramic coating slurry; where the average particle size of the ceramic particles was 2 μm.

The first polymer binder polyacrylic acid (Mw=4500), the thickener sodium carboxymethyl cellulose (Mw=7.6×10³), and the wetting agent polyoxyethylene ether (Mw=6000) were mixed in a mass ratio of 91:0.5:8.5, deionized water was added as a solvent, and the resulting mixture was well stirred to produce a first adhesive coating slurry with a solid content of 75 wt %; where the average particle size of the first polymer binder was 1.6 μm; and the first polymer binder was a non-core-shell structure.

The second polymer binder polyvinylidene fluoride (Mw=8×10⁵) and the auxiliary binder methacrylic acid were mixed in a mass ratio of 90:10, deionized water was added as a solvent, and the resulting mixture was well stirred to produce a second adhesive coating slurry with a solid content of 76 wt %; where the average particle size of the second polymer binder was 25 μm; and the second polymer binder was a non-core-shell structure.

The ceramic coating slurry was applied to one surface of the separator substrate, followed by drying at 60° C., to form a ceramic coating on one surface of the separator substrate; the second adhesive coating slurry was applied to the surface of the ceramic coating far from the separator substrate, followed by drying at 60° C., to form a second adhesive coating on the surface of the ceramic coating far from the separator substrate; and the first adhesive coating slurry was applied to the other surface of the separator substrate, followed by drying at 60° C., to form a first adhesive coating on the other surface of the separator substrate, thereby obtaining the separator (the structure is shown in FIG. 4, but is not limited to that shown in FIG. 4).

The single-side coating weight Cw₁ of the first adhesive coating was 0.0006 mg/mm², the thickness H₁ of the first adhesive coating was 2 μm, the single-side coating weight Cw₂ of the second adhesive coating was 0.0012 mg/mm², and the thickness H₂ of the second adhesive coating was 12 μm. The single-side coating weight of the ceramic coating was Cw₃=10.0023 mg/mm², and the thickness H₃ of the ceramic coating was 1 μm. The coverage Cr₁ of the first polymer binder in the first adhesive coating per unit area was 50%, and the coverage Cr₂ of the second polymer binder in the second adhesive coating per unit area was 50%.

### <Preparation of Positive Electrode Plate>

The positive electrode active material lithium cobalt oxide (LiCoO₂, Dᵥ99=30 μm, Dᵥ50=12 μm), the positive electrode conductive agent Super P, and the positive electrode binder polyvinylidene fluoride (PVDF, Mw=7×10⁶) were mixed in a mass ratio of 97:1:2, N-methylpyrrolidone (NMP) was added as a solvent, and the resulting mixture was stirred in a vacuum mixer until a positive electrode slurry with a solid content of 75 wt % and a uniform system was obtained. The positive electrode slurry was evenly applied to the positive electrode main area of one surface of a 10 μm-thick positive electrode current collector aluminum foil, followed by drying at 95° C., to obtain a positive electrode plate with single-side coating of the positive electrode active material layer. Then, the above steps were repeated on the positive electrode main area of the other surface of the aluminum foil to obtain a positive electrode plate with double-side coating of the positive electrode active material layer. Then, cold pressing, slitting, and stripping were performed. After stripping, drying was performed at 85° C. for 4 h under vacuum to obtain a positive electrode plate with a specification of 54 mm×1580 mm for later use. The single-layer thickness of the positive electrode active material layer was 38.5 μm, the thickness of the positive electrode plate was 87 μm, 18 positive electrode tabs were integrally formed by die-cutting in the tab area of the positive electrode current collector, and the coating weight W_{z} of the positive electrode active material layer was 9.08 mg/cm².

### <Preparation of Negative Electrode Plate>

The negative electrode active material (Dᵥ99-25 μm, Dᵥ50=10 μm), the negative electrode conductive agent Super P, the stabilizer sodium carboxymethyl cellulose (CMC-Na, Mw=7×10⁵), and the negative electrode binder styrene-butadiene rubber (SBR, Mw=5×10⁶) were mixed in a mass ratio of 96.5:1.0:1.0:1.5, then deionized water was added as a solvent, and the resulting mixture was stirred in a vacuum mixer until a negative electrode slurry with a solid content of 51 wt % and a uniform system was obtained. The negative electrode slurry was evenly applied to the negative electrode main area of one surface of a 6 μm-thick negative electrode current collector copper foil, followed by drying at 85° C., to obtain a negative electrode plate with single-side coating of the negative electrode active material layer. Then, the above steps were repeated on the negative electrode main area of the other surface of the copper foil to obtain a negative electrode plate with double-side coating of the negative electrode active material layer. Then, cold pressing, slitting, and stripping were performed. After stripping, drying was performed at 110° C. for 4 h under vacuum to obtain a negative electrode plate with a specification of 58 mm×1600 mm for later use. The single-layer thickness of the negative electrode active material layer was 58.5 μm, the thickness of the negative electrode plate was 123 μm, 18 negative electrode tabs were integrally formed by die-cutting in the tab area of the negative electrode current collector, and the coating weight W_{f} of the negative electrode active material layer was 4.54 mg/cm². The types of the negative electrode active materials are shown in Table 3.

### <Preparation of Electrolyte>

In an environment with a water content less than 10 ppm, propyl propionate, ethylene carbonate, and diethyl carbonate were mixed in a mass ratio of 40:30:30 as a solvent. The lithium salt lithium hexafluorophosphate (LiPF₆), the solvent, and the additive succinonitrile were formulated in a mass ratio of 15:83:2 to obtain the electrolyte, where the mass percentage of the lithium salt was 15%.

### <Preparation of Lithium-Ion Battery>

The separator, positive electrode plate, separator, and negative electrode plate were stacked in order, with the separator sandwiched between the positive electrode plate and the negative electrode plate for separation. The first adhesive coating in the separator was close to the negative electrode plate, and the second adhesive coating was close to the positive electrode plate. The resulting stack was wound to obtain the electrode assembly. The electrode assembly was placed in an aluminum-plastic film housing and dried. Then the electrolyte was injected, and processes such as vacuum packaging, standing, formation, capacity testing, degassing, and trimming were performed to obtain the lithium-ion battery.

### Examples 1-2 to 1-21

The rest steps were the same as Example 1-1, except that the related preparation parameters were adjusted according to Table 1.

### Examples 2-1 to 2-12

The rest steps were the same as Example 1-1, except that the related preparation parameters were adjusted according to Table 2.

### Example 3-1

The rest steps were the same as Example 1-1, except that the related preparation parameters were adjusted according to Table 3.

### Examples 3-2 to 3-4

The rest steps were the same as Example 1-1, except that artificial graphite with the surface coated with amorphous carbon was selected as the negative electrode active material in <Preparation of negative electrode plate>. The mass ratio of artificial graphite to amorphous carbon was adjusted according to Table 3.

### Examples 3-5 and 3-6

The rest steps were the same as Example 1-1, except that the related preparation parameters were adjusted according to Table 3.

### Comparative Examples 1 to 12

The rest steps were the same as Example 1-1, except that the related preparation parameters were adjusted according to Table 1.

### Comparative Example 13

### <Preparation of Separator>

The ceramic coating slurry was applied to one surface of the separator substrate, followed by drying at 60° C., to form a ceramic coating on one surface of the separator substrate; the first adhesive coating slurry was applied to the surface of the ceramic coating far from the separator substrate, followed by drying at 60° C., to form a first adhesive coating on the surface of the ceramic coating far from the separator substrate; and the first adhesive coating slurry was applied to the other surface of the separator substrate, followed by drying at 60° C., to form a first adhesive coating on the other surface of the separator substrate, thereby obtaining the separator.

The rest steps were the same as Example 1-1.

### <Preparation of Lithium-Ion Battery>

The rest steps were the same as Example 1-1, except that the surface of the separator provided with the ceramic coating was closer to the positive electrode plate.

<Preparation of positive electrode plate>, <Preparation of negative electrode plate>, and <Preparation of electrolyte> were the same as Comparative Example 1.

### Comparative Example 14

### <Preparation of Separator>

The ceramic coating slurry was applied to one surface of the separator substrate, followed by drying at 60° C., to form a ceramic coating on one surface of the separator substrate; the second adhesive coating slurry was applied to the surface of the ceramic coating far from the separator substrate, followed by drying at 60° C., to form a second adhesive coating on the surface of the ceramic coating far from the separator substrate; and the second adhesive coating slurry was applied to the other surface of the separator substrate, followed by drying at 60° C., to form a second adhesive coating on the other surface of the separator substrate, thereby obtaining the separator. The rest steps were the same as Example 1-1.

<Preparation of positive electrode plate>, <Preparation of negative electrode plate>, <Preparation of electrolyte>, and <Preparation of lithium-ion battery> were the same as Comparative Example 13.

### Comparative Example 15

The rest steps were the same as Example 1-1, except that the related preparation parameters were adjusted according to Table 1.

### Comparative Example 16

<Preparation of separator> and <Preparation of lithium-ion battery> were the same as Comparative Example 14. The rest steps were the same as Example 1-1, except that the related preparation parameters were adjusted according to Table 1.

### Comparative Example 17

<Preparation of separator> and <Preparation of lithium-ion battery> were the same as Comparative Example 13. The rest steps were the same as Example 1-1, except that the related preparation parameters were adjusted according to Table 1.

### Comparative Example 18

<Preparation of separator> and <Preparation of lithium-ion battery> were the same as Comparative Example 14. The rest steps were the same as Example 1-1, except that the related preparation parameters were adjusted according to Table 1.

Table 1 to Table 3 show the preparation parameters and performance parameters of each example and comparative example.

TABLE 1

| | | | | | | | | Average | Average | | | Capacity | |
|---|---|---|---|---|---|---|---|---|---|---|---|---|---|
| | | | | Dᵥ99 of | Dᵥ50 of | Dᵥ99 of | Dᵥ50 of | particle | particle | | | retention | |
| | | | | positive | positive | negative | negative | size of | size of | | | rate | |
| | | | | electrode | electrode | electrode | electrode | first | second | | | after | |
| | W_{f} = | | W_{z} = | active | active | active | active | polymer | polymer | | | 1000 | |
| | (mg/ | | (mg/ | material | material | material | material | binder | binder | F₁ | F₂ | cycles at | Swelling |
| | cm²) | W_{z}/W_{f} | cm²) | (μm) | (μm) | (μm) | (μm) | (μm) | (μm) | (N/m) | (N/m) | 25° C. (%) | rate (%) |
| Example 1-1 | 4.54 | 2 | 9.08 | 30 | 12 | 25 | 10 | 1.6 | 25 | 8.3 | 12.4 | 85.5 | 8.2 |
| Example 1-2 | 3.25 | 2 | 6.50 | 30 | 12 | 25 | 10 | 1.6 | 25 | 8.6 | 12.3 | 87.6 | 8.7 |
| Example 1-3 | 5.84 | 2 | 11.68 | 30 | 12 | 25 | 10 | 1.6 | 25 | 8.2 | 12.6 | 81.2 | 8.3 |
| Example 1-4 | 4.54 | 1.6 | 7.26 | 30 | 12 | 25 | 10 | 1.6 | 25 | 8.1 | 12.5 | 83.4 | 9.3 |
| Example 1-5 | 4.54 | 2.2 | 9.99 | 30 | 12 | 25 | 10 | 1.6 | 25 | 8.0 | 12.3 | 82.2 | 8.4 |
| Example 1-6 | 3.25 | 1.6 | 5.20 | 30 | 12 | 25 | 10 | 1.6 | 25 | 8.1 | 12.2 | 74.6 | 8.8 |
| Example 1-7 | 5.84 | 2.2 | 12.85 | 30 | 12 | 25 | 10 | 1.6 | 25 | 8.5 | 12.4 | 73.2 | 8.3 |
| Example 1-8 | 4.54 | 2 | 9.08 | 29 | 11 | 25 | 10 | 1.6 | 25 | 8.3 | 12.1 | 85.2 | 8.8 |
| Example 1-9 | 4.54 | 2 | 9.08 | 27 | 10 | 25 | 10 | 1.6 | 25 | 7.9 | 12.2 | 80.6 | 9.3 |
| Example 1- | 4.54 | 2 | 9.08 | 28 | 11 | 25 | 10 | 1.6 | 25 | 8.2 | 12.1 | 83.4 | 9.0 |
| 10 | | | | | | | | | | | | | |
| Example 1- | 4.54 | 2 | 9.08 | 31 | 14 | 25 | 10 | 1.6 | 25 | 8.6 | 12.3 | 83.2 | 8.2 |
| 11 | | | | | | | | | | | | | |
| Example 1- | 4.54 | 2 | 9.08 | 33 | 15 | 25 | 10 | 1.6 | 25 | 8.7 | 12.5 | 81.4 | 8.2 |
| 12 | | | | | | | | | | | | | |
| Example 1- | 4.54 | 2 | 9.08 | 30 | 12 | 23 | 7 | 1.6 | 25 | 8.5 | 12.5 | 80.6 | 9.8 |
| 13 | | | | | | | | | | | | | |
| Example 1- | 4.54 | 2 | 9.08 | 30 | 12 | 24 | 8 | 1.6 | 25 | 8.5 | 12.7 | 82.4 | 8.8 |
| 14 | | | | | | | | | | | | | |
| Example 1- | 4.54 | 2 | 9.08 | 30 | 12 | 26 | 10 | 1.6 | 25 | 8.3 | 12.8 | 83.8 | 8.2 |
| 15 | | | | | | | | | | | | | |
| Example 1- | 4.54 | 2 | 9.08 | 30 | 12 | 28 | 12 | 1.6 | 25 | 8.2 | 12.1 | 80.2 | 8.3 |
| 16 | | | | | | | | | | | | | |
| Example 1- | 4.54 | 2 | 9.08 | 30 | 12 | 25 | 10 | 0.3 | 25 | 8.2 | 8.7 | 80.2 | 13.5 |
| 17 | | | | | | | | | | | | | |
| Example 1- | 4.54 | 2 | 9.08 | 30 | 12 | 25 | 10 | 3 | 25 | 8.5 | 13.4 | 83.6 | 8.2 |
| 18 | | | | | | | | | | | | | |
| Example 1- | 4.54 | 2 | 9.08 | 30 | 12 | 25 | 10 | 1.6 | 10 | 5.4 | 12.1 | 81.0 | 14.6 |
| 19 | | | | | | | | | | | | | |
| Example 1- | 4.54 | 2 | 9.08 | 30 | 12 | 25 | 10 | 1.6 | 38 | 10.3 | 12.3 | 77.3 | 7.9 |
| 20 | | | | | | | | | | | | | |
| Example 1- | 4.54 | 2 | 9.08 | 30 | 12 | 25 | 10 | 1.6 | 25 | 8.2 | 4.5 | 83.2 | 16.3 |
| 21 | | | | | | | | | | | | | |
| Comparative | 2.5 | 2 | 5 | 30 | 12 | 25 | 10 | 1.6 | 25 | 8.8 | 12.1 | 82.6 | 8.6 |
| Example 1 | | | | | | | | | | | | | |
| Comparative | 6.5 | 2 | 13 | 30 | 12 | 25 | 10 | 1.6 | 25 | 8.2 | 12.5 | 54.3 | 8.3 |
| Example 2 | | | | | | | | | | | | | |
| Comparative | 4.54 | 1 | 4.54 | 30 | 12 | 25 | 10 | 1.6 | 25 | 8.4 | 12.7 | 33.3 | 8.7 |
| Example 3 | | | | | | | | | | | | | |
| Comparative | 4.54 | 3 | 13.62 | 30 | 12 | 25 | 10 | 1.6 | 25 | 8.3 | 11.8 | 43.3 | 8.2 |
| Example 4 | | | | | | | | | | | | | |
| Comparative | 2 | 2.5 | 5 | 30 | 12 | 25 | 10 | 1.6 | 25 | 8.1 | 12.1 | 40.2 | 8.9 |
| Example 5 | | | | | | | | | | | | | |
| Comparative | 4.54 | 2 | 9.08 | 40 | 22 | 25 | 10 | 1.6 | 25 | 8.7 | 12.2 | 60.3 | 8.2 |
| Example 6 | | | | | | | | | | | | | |
| Comparative | 4.54 | 2 | 9.08 | 30 | 12 | 35 | 20 | 1.6 | 25 | 8.7 | 12.4 | 62.2 | 8.2 |
| Example 7 | | | | | | | | | | | | | |
| Comparative | 4.54 | 2 | 9.08 | 40 | 22 | 35 | 20 | 1.6 | 25 | 8.3 | 12.3 | 47.3 | 8.2 |
| Example 8 | | | | | | | | | | | | | |
| Comparative | 4.54 | 2 | 9.08 | 30 | 12 | 25 | 10 | 0.1 | 25 | 8.2 | 3.9 | 70.4 | 18.5 |
| Example 9 | | | | | | | | | | | | | |
| Comparative | 4.54 | 2 | 9.08 | 30 | 12 | 25 | 10 | 4 | 25 | 8.4 | 14.6 | 65.4 | 8.1 |
| Example 10 | | | | | | | | | | | | | |
| Comparative | 4.54 | 2 | 9.08 | 30 | 12 | 25 | 10 | 1.6 | 5 | 1.9 | 12.3 | 64.2 | 19.7 |
| Example 11 | | | | | | | | | | | | | |
| Comparative | 4.54 | 2 | 9.08 | 30 | 12 | 25 | 10 | 1.6 | 43 | 11.5 | 12.4 | 50.3 | 8.0 |
| Example 12 | | | | | | | | | | | | | |
| Comparative | 4.54 | 2 | 9.08 | 30 | 12 | 25 | 10 | 1.6 | / | 12.7 | 12.3 | 44.1 | 7.3 |
| Example 13 | | | | | | | | | | | | | |
| Comparative | 4.54 | 2 | 9.08 | 30 | 12 | 25 | 10 | / | 25 | 8.4 | 2.3 | 55.2 | 20.2 |
| Example 14 | | | | | | | | | | | | | |
| Comparative | 4.54 | 2 | 9.08 | 15 | 7 | 25 | 20 | 1.6 | 25 | 8.6 | 12.6 | 52.3 | 25.8 |
| Example 15 | | | | | | | | | | | | | |
| Comparative | 4.54 | 2 | 9.08 | 30 | 12 | 18 | 8 | 1.6 | 25 | 8.4 | 11.9 | 55.3 | 28.7 |
| Example 16 | | | | | | | | | | | | | |
| Comparative | 4.54 | 1 | 4.54 | 30 | 12 | 25 | 10 | 1.6 | / | 12.3 | 12.3 | 30.3 | 7.8 |
| Example 17 | | | | | | | | | | | | | |
| Comparative | 2 | 2.5 | 5 | 40 | 22 | 35 | 20 | / | 25 | 8.4 | 2.1 | 37.8 | 22.4 |
| Example 18 | | | | | | | | | | | | | |

Note: ″/″ in Table 1 indicates no corresponding parameter. The difference between Example 1-1
and Example 1-21 in Table 1 is that: in the lithium-ion battery of Example 1-1, the first adhesive coating in
the separator is close to the negative electrode plate, and the second adhesive coating is close to the positive
electrode plate; and in the lithium-ion battery of Example 1-21, the first adhesive coating in the separator is
close to the positive electrode plate, and the second adhesive coating is close to the negative electrode plate.

From Examples 1-1 to 1-21 and Comparative Examples 1 to 18, it can be seen that in the secondary battery according to the embodiments of this application, a first adhesive coating and a second adhesive coating are respectively provided on two sides of the separator, the Dᵥ50 of the first polymer binder in the first adhesive coating and the Dᵥ50 of the second polymer binder in the second adhesive coating are set within the ranges of this application, the Dᵥ99 of the positive electrode active material and the Dᵥ99 of the negative electrode active material are set within the ranges of this application, and the coating weight W_{f} of the negative electrode active material layer and the coating weight W_{z} of the positive electrode active material layer are set within the ranges of this application, achieving a higher adhesion force F₁ of the separator to the positive electrode plate and a higher adhesion force F₂ of the separator to the negative electrode plate. The secondary battery exhibits a higher capacity retention rate at a charging rate of 10 C, indicating that the secondary battery has better cycling performance under fast-charging conditions. The secondary battery has a lower swelling rate in thickness after storage at 80° C. for 8 h, indicating that the secondary battery has good high-temperature stability. Thus, the secondary battery in the embodiments of this application can achieve both good cycling performance and high-temperature stability under fast-charging conditions.

In Comparative Example 1, the coating weights of the positive electrode active material and the negative electrode active material are both too low. Although the resulting lithium-ion battery has good cycling performance and low swelling rate, due to the excessively low coating weights of the positive electrode active material layer and the negative electrode active material layer, the costs of precisely controlling the coating weights in actual industrial production are too high, the yield of lithium-ion batteries obtained in large-scale production is too low, and the energy density of the obtained lithium-ion batteries is too low, which cannot meet the needs of actual production and is not suitable for industrial production applications. For the secondary batteries of Comparative Examples 2 to 5, the coating weight W_{f} of the negative electrode active material layer and/or the coating weight W_{z} of the positive electrode active material layer is not within the range of this application. For the secondary batteries of Comparative Examples 6 to 8, the Dᵥ99 of the positive electrode active material and/or the Dᵥ99 of the negative electrode active material are not within the ranges of this application. For the secondary batteries of Comparative Examples 9 and 10, the Dᵥ50 of the first polymer binder in the separator is not within the ranges of this application. For the secondary batteries of Comparative Examples 11 and 12, the Dᵥ50 of the second polymer binder in the separator is not within the ranges of this application. For the secondary battery of Comparative Example 13, both sides of the separator are provided with the first adhesive coating, which is not the separator structure of this application. For the secondary battery of Comparative Example 14, both sides of the separator are provided with the second adhesive coating, which is not the separator structure of this application. For the secondary battery of Comparative Example 15, the Dᵥ99 of the positive electrode active material is not within the range of this application. For the secondary battery of Comparative Example 16, the Dᵥ99 of the negative electrode active material is not within the ranges of this application. For the secondary battery of Comparative Example 17, the coating weight W_{z} of the positive electrode active material layer is not within the ranges of this application, and both sides of the separator are provided with the first adhesive coating, which is not the separator structure of this application. For the secondary battery of Comparative Example 18, the Dᵥ99 of the positive electrode active material, the Dᵥ99 of the negative electrode active material, the coating weight W_{f} of the negative electrode active material layer, the coating weight W_{z} of the positive electrode active material layer, and the separator are all not within the ranges of this application. For the secondary batteries of Comparative Examples 1 to 18, the adhesion force F₁ of the separator to the positive electrode plate and/or the adhesion force F₂ of the separator to the negative electrode plate are lower, and the secondary battery has a lower capacity retention rate at a charging rate of 10 C, indicating that the secondary battery has poorer cycling performance under fast-charging conditions; or the secondary battery has a higher swelling rate in thickness after storage at 80° C. for 8 h, indicating that the secondary battery has poorer high-temperature stability. That is, Comparative Examples 2 to 18 cannot achieve high cycling performance and low swelling rate at the same time.

The coating weight W_{z} of the positive electrode active material layer typically affects the cycling performance and high-temperature stability of the secondary battery. From Examples 1~4 to 1-7, it can be seen that the secondary battery using W_{z} within the ranges of this application has a higher capacity retention rate at a charging rate of 10 C, indicating that the secondary battery has good cycling performance; and the secondary battery also has a lower swelling rate in thickness after storage at 80° C. for 8 h under fast-charging conditions, indicating that the secondary battery has good high-temperature stability. In Example 1-6, the coating weight W_{z} of the positive electrode active material layer is low, and the coating weight of the negative electrode active material layer is closer to the coating weight of the positive electrode active material layer. When the potential of the secondary battery is reached, the delithiation speed of the positive electrode increases, which may lead to over-delithiation of the positive electrode, reducing the capacity retention rate of the lithium-ion battery. Furthermore, although the charging speed of the lithium-ion battery is faster and the impedance is lower, the energy density of the lithium-ion battery is low, making it difficult to control the coating weight of the positive electrode active material layer in actual industrial production. In Example 1-7, the coating weight W_{z} of the positive electrode active material layer is high, and the coating weight of the negative electrode active material layer differs greatly from the coating weight of the positive electrode active material layer. During fast charging of the lithium-ion battery, lithium ions in the positive electrode plate cannot be released in time, and lithium ions cannot be intercalated into the negative electrode plate in time, which easily leads to lithium precipitation, reducing the capacity retention rate of the lithium-ion battery.

The Dᵥ50 of the positive electrode active material and the Dᵥ50 of the negative electrode active material typically affect the cycling performance and high-temperature stability of the secondary battery. From Examples 1-1, and 1-8 to 1-16, it can be seen that the secondary battery using the Dᵥ50 of the positive electrode active material and the Dᵥ50 of the negative electrode active material within the ranges of this application has a high capacity retention rate at a charging rate of 10 C and a low swelling rate in thickness after storage at 80° C. for 8 h, indicating that the secondary battery has both good cycling performance and good high-temperature stability under fast-charging conditions.

The position relationship between the first adhesive coating and second adhesive coating in the separator and the positive electrode plate and the negative electrode plate typically affects the kinetic performance, cycling performance, and mechanical reliability of the secondary battery. From Examples 1-1 and 1-21, it can be seen that the second polymer binder polyvinylidene fluoride has poor adhesion with the negative electrode plate, resulting in a lower adhesion force F₂ of the separator to the negative electrode plate, causing the swelling rate of Example 1-21 to be larger than that of Example 1-1. Additionally, in Example 1-21, since the second adhesive coating corresponds to the negative electrode plate side, the lithium ion transmission path is longer during fast charging, leading to lower kinetic performance of Example 1-21, that is, a lower capacity retention rate.

TABLE 2

| | | | | | | | | | | | Capacity | |
|---|---|---|---|---|---|---|---|---|---|---|---|---|
| | | | | | | | | | | | retention | |
| | | | | | | | | | | | rate after | |
| | | | | | | | | | | | 1000 | |
| | First polymer | Second polymer | Cr₁ | Cr₂ | Cw₁ | Cw₂ | H₁ | H₂ | F₁ | F₂ | cycles at | Swelling |
| | binder | binder | (%) | (%) | (mg/mm²) | (mg/mm²) | (μm) | (μm) | (μm) | (μm) | 25° C. (%) | rate (%) |
| Example | Polyacrylic acid | Polyvinylidene fluoride | 50 | 50 | 0.0006 | 0.0012 | 2 | 12 | 8.3 | 12.4 | 85.5 | 8.2 |
| 1-1 | | | | | | | | | | | | |
| Example | Polyacrylic acid | Polyvinylidene fluoride | 40 | 50 | 0.0005 | 0.0012 | 0.2 | 12 | 8.2 | 9.6 | 83.3 | 9.8 |
| 2-1 | | | | | | | | | | | | |
| Example | Polyacrylic acid | Polyvinylidene fluoride | 60 | 50 | 0.0010 | 0.0012 | 4.0 | 12 | 8.4 | 14.4 | 82.5 | 8.1 |
| 2-2 | | | | | | | | | | | | |
| Example | Polyacrylic acid | Polyvinylidene fluoride | 15 | 50 | 0.00006 | 0.0012 | 0.15 | 12 | 8 | 8.4 | 76.6 | 12.2 |
| 2-3 | | | | | | | | | | | | |
| Example | Polyacrylic acid | Polyvinylidene fluoride | 75 | 50 | 0.0015 | 0.0012 | 5.2 | 12 | 8 | 15.6 | 73.2 | 8.0 |
| 2-4 | | | | | | | | | | | | |
| Example | Polyacrylic acid | Polyvinylidene fluoride | 50 | 40 | 0.0006 | 0.0004 | 2 | 5 | 6.4 | 12 | 82.1 | 9.3 |
| 2-5 | | | | | | | | | | | | |
| Example | Polyacrylic acid | Polyvinylidene fluoride | 50 | 60 | 0.0006 | 0.002 | 2 | 20 | 9.6 | 12 | 81.2 | 8.0 |
| 2-6 | | | | | | | | | | | | |
| Example | Polyacrylic acid | Polyvinylidene fluoride | 50 | 15 | 0.0006 | 0.0003 | 2 | 3.3 | 5.6 | 12 | 78.3 | 13.4 |
| 2-7 | | | | | | | | | | | | |
| Example | Polyacrylic acid | Polyvinylidene fluoride | 50 | 78 | 0.0006 | 0.0027 | 2 | 24 | 10.4 | 12 | 76.5 | 7.8 |
| 2-8 | | | | | | | | | | | | |
| Example | Polyacrylonitrile | Polyvinylidene fluoride | 50 | 50 | 0.0006 | 0.0012 | 2 | 12 | 8.3 | 12.6 | 84.2 | 8.7 |
| 2-9 | (Mw = 7000) | | | | | | | | | | | |
| Example | Core + shell = | Polyvinylidene fluoride | 50 | 50 | 0.0006 | 0.0012 | 2 | 12 | 8.6 | 13.5 | 85.1 | 7.2 |
| 2-10 | polyethyl acrylate | | | | | | | | | | | |
| | (Mw = 95000)+ | | | | | | | | | | | |
| | polymethyl acrylate | | | | | | | | | | | |
| | (Mw = 45000), core- | | | | | | | | | | | |
| | shell mass ratio 1:1 | | | | | | | | | | | |
| Example | Polyacrylic acid | Polyvinylidene chloride | 50 | 50 | 0.0006 | 0.0012 | 2 | 12 | 9.2 | 12.3 | 83.8 | 7.6 |
| 2-11 | | | | | | | | | | | | |
| Example | Polyacrylic acid | Core + shell = | 50 | 50 | 0.0006 | 0.0012 | 2 | 12 | 8.6 | 12.7 | 83.9 | 8.5 |
| 2-12 | | polyhexafluoropropylene | | | | | | | | | | |
| | | (Mw = 230000) + polyviny | | | | | | | | | | |
| | | 1 chloride (Mw = 45000), | | | | | | | | | | |
| | | core-shell mass ratio 1:1 | | | | | | | | | | |

The coverage Cr₁ of the first polymer binder in the first adhesive coating per unit area, the single-side coating weight Cw₁ of the first adhesive coating, and the thickness H₁ of the first adhesive coating typically affect the cycling kinetic performance and high-temperature stability of the secondary battery. From Example 1-1 and Examples 2-1 to 2-4, it can be seen that the secondary battery using the coverage Cr₁ of the first polymer binder in the first adhesive coating per unit area, the single-side coating weight Cw₁ of the first adhesive coating, and the thickness H₁ of the first adhesive coating within the ranges of this application has a larger adhesion force of the separator to the positive electrode plate or the negative electrode plate, a higher capacity retention rate at a charging rate of 10 C, and a lower swelling rate in thickness after storage at 80° C. for 8 h, indicating that the secondary battery has both good cycling performance and good high-temperature stability under fast-charging conditions.

The coverage Cr₂ of the second polymer binder in the second adhesive coating per unit area, the single-side coating weight Cw₂ of the second adhesive coating, and the thickness H₂ of the second adhesive coating typically affect the cycling performance and high-temperature stability of the secondary battery. From Example 1-1 and Examples 2-5 to 2-8, it can be seen that the secondary battery using the coverage Cr₂ of the second polymer binder in the second adhesive coating per unit area, the single-side coating weight Cw₂ of the second adhesive coating, and the thickness H₂ of the second adhesive coating within the ranges of this application has a larger adhesion force of the separator to the positive electrode plate or the negative electrode plate, and a higher capacity retention rate at a charging rate of 10 C, indicating that the secondary battery has good cycling performance under fast-charging conditions. The secondary battery also has a lower swelling rate in thickness after storage at 80° C. for 8 h, indicating that the secondary battery has good high-temperature stability.

The type of the first polymer binder typically affects the cycling performance and high-temperature stability of the secondary battery. From Example 1-1 and Examples 2-9 to 2-10, it can be seen that the secondary battery using the type of the first polymer binder within the ranges of this application has a larger adhesion force of the separator to the positive electrode plate or the negative electrode plate, and a higher capacity retention rate at a charging rate of 10 C, indicating that the secondary battery has good cycling performance under fast-charging conditions. The secondary battery also has a lower swelling rate in thickness after storage at 80° C. for 8 h, indicating that the secondary battery has good high-temperature stability.

The type of the second polymer binder typically affects the cycling performance and high-temperature stability of the secondary battery. From Example 1-1 and Examples 2-11 to 2-12, it can be seen that the secondary battery using the type of the second polymer binder within the ranges of this application has a larger adhesion force of the separator to the positive electrode plate or the negative electrode plate, and a higher capacity retention rate at a charging rate of 10 C, indicating that the secondary battery has good cycling performance under fast-charging conditions. The secondary battery also has a lower swelling rate in thickness after storage at 80° C. for 8 h, indicating that the secondary battery has good high-temperature stability.

TABLE 3

| | | | | Capacity | |
|---|---|---|---|---|---|
| | | | | retention | |
| | | | Positive | rate | |
| | Negative | | electrode | after 1000 | Swelling |
| | electrode | | active | cycles at | rate |
| | active material | I_{d}/I_{g} | material | 25° C. (%) | (%) |
| Example | Artificial graphite | 0.8 | Lithium | 85.2 | 8.3 |
| 1-1 | | | cobalt | | |
| | | | oxide | | |
| Example | Silicon-carbon | 0 | Lithium | 80.1 | 9.4 |
| 3-1 | material | | cobalt | | |
| | (mass ratio | | oxide | | |
| | of silicon to | | | | |
| | carbon: 5:95) | | | | |
| Example | Artificial graphite + | 0.2 | Lithium | 81.2 | 8.2 |
| 3-2 | amorphous carbon | | cobalt | | |
| | (mass ratio: 98:2) | | oxide | | |
| Example | Artificial graphite + | 0.5 | Lithium | 83.2 | 8.2 |
| 3-3 | amorphous carbon | | cobalt | | |
| | (mass ratio: 95:5) | | oxide | | |
| Example | Artificial graphite + | 1 | Lithium | 82.1 | 8.5 |
| 3-4 | amorphous carbon | | cobalt | | |
| | (mass ratio: 90:10) | | oxide | | |
| Example | Artificial graphite | 0.8 | Lithium | 83.1 | 8.5 |
| 3-5 | | | iron | | |
| | | | phosphate | | |
| Example | Artificial graphite | 0.8 | Lithium | 82.3 | 8.7 |
| 3-6 | | | nickel | | |
| | | | cobalt | | |
| | | | manganese | | |
| | | | oxide | | |
| | | | (NCM811) | | |

Note:
“/” in Table 3 indicates no corresponding parameter.

The type of the negative electrode active material and the I_{d}/I_{g} value of the carbon-based material typically affect the cycling performance and high-temperature stability of the secondary battery. From Example 1-1 and Examples 3-1 to 3-4, it can be seen that the secondary battery using the type of the negative electrode active material and the I_{d}/I_{g} value of the carbon-based material within the ranges of this application has a higher capacity retention rate at a charging rate of 10 C, indicating that the secondary battery has good cycling performance under fast-charging conditions. The secondary battery also has a lower swelling rate in thickness after storage at 80° C. for 8 h, indicating that the secondary battery has good high-temperature stability. FIG. 6 is a Raman spectrum of Example 3-3. From FIG. 6, it can be seen that in the Raman spectrum of the high-kinetics negative electrode material, the I_{d}/I_{g} value is relatively high, indicating a good surface activity.

The type of the positive electrode active material typically affects the cycling performance and high-temperature stability of the secondary battery. From Example 1-1, Example 3-5, and Example 3-6, it can be seen that the secondary battery using the type of the positive electrode active material and the I_{d}/I_{g} value of the carbon-based material within the ranges of this application has a higher capacity retention rate at a charging rate of 10 C, indicating that the secondary battery has good cycling performance under fast-charging conditions. The secondary battery also has a lower swelling rate in thickness after storage at 80° C. for 8 h, indicating that the secondary battery has good high-temperature stability.

It should be noted that in this specification, relational terms such as first and second are used solely to distinguish one entity or operation from another entity or operation, but do not necessarily require or imply any actual relationship or order between such entities or operations. Moreover, the terms “include”, “comprise”, or any other variants are intended to cover a non-exclusive inclusion, such that a process, method, article, or device that includes a list of elements not only includes those elements but also includes other elements that are not expressly listed, or further includes elements inherent to such process, method, article, or device.

The embodiments in this specification are described in an interrelated manner. For a part that is the same or similar between different embodiments, reference may be made between the embodiments. Each embodiment focuses on the differences from other embodiments.

The foregoing descriptions are merely preferred embodiments of this application, but are not intended to limit this application. Any modification, equivalent replacement, or improvement made without departing from the spirit and principle of this application shall fall within the protection scope of this application.

What is claimed is:

1. A secondary battery, comprising an electrode assembly, wherein the electrode assembly comprises a positive electrode plate, a negative electrode plate, and a separator; wherein the positive electrode plate comprises a positive electrode active material layer, the positive electrode active material layer comprising a positive electrode active material; and the negative electrode plate comprises a negative electrode active material layer, the negative electrode active material layer comprising a negative electrode active material;
a coating weight of the positive electrode active material layer is W_{z}, a coating weight of the negative electrode active material layer is W_{f}, and W_{z} and W_{f} satisfy: 1.6W_{f}≤W_{z}≤2.2W_{f}, and 3.25 mg/cm²≤W_{f}≤5.84 mg/cm²;
Dᵥ99 of the positive electrode active material is 27 μm to 33 μm, and Dᵥ99 of the negative electrode active material is 23 μm to 28 μm; and
the separator comprises a separator substrate, a first adhesive coating, and a second adhesive coating; wherein the first adhesive coating and the second adhesive coating are respectively provided on two sides of the separator substrate; the first adhesive coating comprises a first polymer binder, and an average particle size of the first polymer binder is 0.3 μm to 3 μm; and the second adhesive coating comprises a second polymer binder, and an average particle size of the second polymer binder is 10 μm to 38 μm.

2. The secondary battery according to claim 1, wherein the first adhesive coating is provided on a side of the separator substrate facing the negative electrode plate, and the second adhesive coating is provided on a side of the separator substrate facing the positive electrode plate.

3. The secondary battery according to claim 1, wherein Dᵥ50 of the positive electrode active material is 10 μm to 15 μm, and Dᵥ50 of the negative electrode active material is 7 μm to 12 μm.

4. The secondary battery according to claim 1, wherein 6.49 mg/cm²≤W_{z}≤11.69 mg/cm².

5. The secondary battery according to claim 1, wherein the Dᵥ99 of the positive electrode active material is 28 μm to 31 μm, and Dᵥ50 is 11 μm to 13 μm; and the Dᵥ99 of the negative electrode active material is 24 μm to 26 μm, and Dᵥ50 is 8 μm to 11 μm.

6. The secondary battery according to claim 1, wherein a thickness of the first adhesive coating is 0.2 μm to 4 μm, and a thickness of the second adhesive coating is 5 μm to 20 μm.

7. The secondary battery according to claim 1, wherein a single-side coating weight of the first adhesive coating is 1×10⁻⁴ mg/mm² to 1×10⁻³ mg/mm², and a single-side coating weight of the second adhesive coating is 4×10⁻⁴ mg/mm² to 2×10⁻³ mg/mm².

8. The secondary battery according to claim 1, wherein coverage of the first polymer binder in the first adhesive coating per unit area is 40% to 60%.

9. The secondary battery according to claim 1, wherein the first polymer binder comprises a core-shell structured first polymer binder or a non-core-shell structured first polymer binder; wherein a polymerized monomer of a core of the core-shell structured first polymer binder comprises at least one of ethyl acrylate, butyl acrylate, ethyl methacrylate, styrene, chlorostyrene, fluorostyrene, methylstyrene, acrylic acid, methacrylic acid, or maleic acid; and a polymerized monomer of a shell of the core-shell structured first polymer binder comprises at least one of methyl acrylate, ethyl acrylate, butyl acrylate, methyl methacrylate, ethyl methacrylate, butyl methacrylate, ethylene, ethyl chloromethyl acrylate, chlorostyrene, fluorostyrene, methylstyrene, acrylonitrile, or methacrylonitrile;
and a polymerized monomer of the non-core-shell structured first polymer binder comprises at least one of acrylic acid, methyl acrylate, butyl acrylate, butadiene, styrene, acrylonitrile, ethylene, fluorostyrene, chlorostyrene, or propylene.

10. The secondary battery according to claim 1, wherein coverage of the second polymer binder in the second adhesive coating per unit area is 40% to 60%.

11. The secondary battery according to claim 1, wherein a polymerized monomer of the second polymer binder comprises at least one of vinylidene chloride, vinylidene fluoride, hexafluoropropylene, ethylene, propylene, vinyl chloride, chloropropene, acrylic acid, methyl acrylate, butyl acrylate, chlorostyrene, fluorostyrene, ethyl acrylate, ethyl methacrylate, methyl methacrylate, butyl methacrylate, ethyl chloromethyl acrylate, styrene, butadiene, or acrylonitrile.

12. The secondary battery according to claim 1, wherein the second polymer binder comprises a core-shell structured second polymer binder or a non-core-shell structured second polymer binder; wherein a polymerized monomer of a shell of the core-shell structured second polymer binder comprises at least one of vinylidene chloride, vinylidene fluoride, hexafluoropropylene, styrene, butadiene, acrylonitrile, acrylic acid, methyl acrylate, or butyl acrylate; and a core of the core-shell structured second polymer binder comprises at least one of ethyl methacrylate, methyl acrylate, ethyl acrylate, butyl acrylate, methyl methacrylate, butyl methacrylate, or ethyl chloromethyl acrylate; and a polymerized monomer of the non-core-shell structured second polymer binder comprises at least one of acrylic acid, methyl acrylate, butyl acrylate, butadiene, styrene, acrylonitrile, ethylene, chlorostyrene, propylene, fluorostyrene, vinylidene chloride, vinylidene fluoride, hexafluoropropylene, vinyl chloride, or chloropropene.

13. The secondary battery according to claim 1, wherein the positive electrode active material comprises at least one of lithium nickel cobalt manganese oxide, lithium nickel cobalt aluminum oxide, lithium iron phosphate, lithium-rich manganese-based material, lithium cobalt oxide, lithium manganese oxide, lithium manganese iron phosphate, or lithium titanate.

14. The secondary battery according to claim 1, wherein the positive electrode active material further comprises a non-metal element; wherein the non-metal element comprises at least one of fluorine, phosphorus, boron, chlorine, silicon, or sulfur.

15. The secondary battery according to claim 1, wherein the negative electrode active material comprises at least one of a carbon-based material, a silicon-based material, or a tin-based material; wherein the carbon-based material comprises at least one of natural graphite, artificial graphite, soft carbon, hard carbon, or mesocarbon microbeads; the silicon-based material comprises at least one of a silicon material, a silicon-carbon material, or a silicon-oxygen material; and the tin-based material comprises at least one of elemental tin, a tin alloy, or a tin oxide.

16. The secondary battery according to claim 15, wherein the negative electrode active material comprises the carbon-based material; and for the carbon-based material, a peak intensity ratio I_{d}/I_{g} of a D peak to a G peak obtained from Raman spectroscopy satisfies: 0.1≤I_{d}/I_{g}≤1.

17. An electric device, comprising the secondary battery according to claim 1.

18. The electric device according to claim 17, wherein the first adhesive coating is provided on a side of the separator substrate facing the negative electrode plate, and the second adhesive coating is provided on a side of the separator substrate facing the positive electrode plate.

19. The electric device according to claim 17, wherein Dᵥ50 of the positive electrode active material is 10 μm to 15 μm, and Dᵥ50 of the negative electrode active material is 7 μm to 12 μm.

20. The electric device according to claim 17, wherein 6.49 mg/cm²≤W_{z}≤11.69 mg/cm².
